(19) United States
(12) Patent Application Publication
(10) Pub. No.: US 2025/0083437 A1
(43) Pub. Date: Mar. 13, 2025

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: KOJI SUDA, Tokyo (JP); NAOKI UCHIDA, Kanagawa (JP); KEN ISHII, Kanagawa (JP); YUSUKE KIYOKAWA, Tokyo (JP); YOSHIYUKI KINOSHITA, Tokyo (JP)

(21) Appl. No.: 18/804,432

(22) Filed: Aug. 14, 2024

(30) Foreign Application Priority Data
Sep. 8, 2023 (JP) 2023-146349
Mar. 13, 2024 (JP) 2024-039121

(51) Int. Cl. B41J 2/045; B41J 2/21; B41J 29/00

(52) U.S. Cl. CPC B41J 2/04561; B41J 2/04535; B41J 2/04551; B41J 2/0456; B41J 2/04573; B41J 2/0458; B41J 2/04591; B41J 2/2128; B41J 2/2135; B41J 2/2139; B41J 2/2142; B41J 29/00

(57) ABSTRACT

A printing apparatus includes a printing head having nozzles configured to eject droplets, a carriage having the printing head mounted thereon, a control unit configured to control the ejection of the droplets from the nozzles, a detection unit configured to detect the droplets ejected from the nozzles, a determination unit configured to determine an ejection state of the nozzles based on the detection result obtained by the detection unit, a reception unit configured to receive a user input to select a mode, and a setting unit configured to set the mode based on the user input, wherein the control unit causes the droplets to be ejected from the nozzles while moving the carriage relative to the detection unit, and the determination unit determines the ejection state of the nozzles based on the detection result of the droplets ejected while moving the carriage relative to the detection unit.

### BACKGROUND

### Field

The present disclosure relates to a printing apparatus for printing by ejecting droplets from a printing head.

### Description of the Related Art

Ink jet printing apparatuses are intended to produce a variety of output articles such as computer aided design (CAD) line drawings, posters, and artworks, and are intended to be used in a variety of environments, including different types of ink. In an ink jet printing apparatus that performs so-called reciprocal printing where ink is ejected while a printing head is reciprocating (scanning), even if the printing head ejects ink at the same position, the landing position of the ejected ink droplets may vary depending on the movement direction of the printing head. The landing position of the ejected ink droplets may also vary depending on the state of the printing head and the type of ink. This causes a problem of deterioration in the fineness of the image formed on a printing medium and the reproducibility of fine lines, resulting in a deterioration in overall image quality.

Japanese Patent Laid-Open No. 2007-152853 discloses a printing apparatus including a derivation unit configured to derive the ink ejection speed. This printing apparatus performs a registration adjustment method for appropriately setting the ejection timing based on the ink ejection speed and the movement speed of the reciprocal printing.

### SUMMARY

In an ink jet printing apparatus, the flying state of ink droplets may vary due to ejection of a plurality of droplets of different sizes at different ejection speeds from a printing head, and the like. In this case, the method of Japanese Patent Laid-Open No. 2007-152853 cannot distinguish and detect the plurality of droplets in different flying states, resulting in low detection accuracy of a nozzle ejection state.

In view of the above problem, the present disclosure aims to detect the nozzle ejection state with high accuracy.

An embodiment of the present invention is a printing apparatus including: a printing head having nozzles from which droplets are ejected; a carriage on which the printing head is mounted; a control unit configured to control the ejection of the droplets from the nozzles; a first detection unit configured to detect the droplets ejected from the nozzles; a first determination unit configured to determine the ejection state of the nozzles based on a detection result obtained by the first detection unit; a reception unit configured to receive a user input for selecting a mode; and a setting unit configured to set the mode based on the user input, wherein the control unit causes the droplets to be ejected from the nozzles while moving the carriage relative to the first detection unit, the first determination unit determines the ejection state of the nozzles based on the detection result of the droplets ejected while moving the carriage relative to the first detection unit, and if it is determined by the first determination unit that the ejection state has changed, processing is executed according to the mode set by the setting unit.

Further features of the present invention will become apparent from the following description of exemplary embodiments with reference to the attached drawings.

### BRIEF DESCRIPTION OF THE DRAWINGS

FIG. 1 is a perspective view showing an appearance of a printing apparatus according to a first embodiment;

FIG. 2 is a perspective view showing an internal configuration of the printing apparatus according to the first embodiment;

FIG. 3 is a block diagram showing a configuration related to control of the printing apparatus according to the first embodiment;

FIGS. 4A and 4B are diagrams showing ink ejection;

FIGS. 5A to 5D are diagrams showing a detection signal that changes with a height of a printing head;

FIG. 6 is a flowchart of processing for detecting an ejection state of nozzles;

FIG. 7 is a conceptual diagram of droplet detection performed while driving a CR;

FIGS. 8A and 8B are diagrams showing detection of droplets (main droplets and satellite droplets);

FIGS. 9A to 9D are schematic diagrams showing calculation of an ejection speed and an ejection volume based on the amount of light received;

FIG. 10 is a flowchart of mode setting processing according to a second embodiment;

FIGS. 11A to 11C are GUI screens related to changing a control processing mode;

FIGS. 12A and 12B are GUI screens related to an automatic restore mode;

FIGS. 13A to 13D are GUI screens related to a warning display mode;

FIG. 14 is a GUI screen related to a function OFF mode;

FIG. 15 is a flowchart of processing in each mode executed based on the result of an ejection state determination sequence according to the second embodiment;

FIGS. 16A to 16C are diagrams showing a detection signal used as a reference according to a third embodiment;

FIG. 17 is a flowchart of test ejection parameter adjustment processing according to the third embodiment;

FIG. 18 is a diagram showing a state where a printing head 201 comes into contact with a printing paper 203;

FIG. 19 is diagram showing the relationship of FIG. 19A and FIG. 19B and FIG. 19A and FIG. 19B collectively show a flowchart of processing of switching the type of ejection state determination sequence according to a fourth embodiment;

FIGS. 20A to 20D are graphs for explaining ejection speed calculation according to a fifth embodiment;

FIG. 21 is a flowchart of the ejection speed calculation processing according to the fifth embodiment;

FIG. 22 is a flowchart of processing of detecting a change in the ejection state according to the fifth embodiment;

FIG. 23 is a flowchart of processing of shifting an ejection monitoring restricted mode according to a sixth embodiment;

FIG. 24 is a flowchart of processing of releasing the ejection monitoring restricted mode according to the sixth embodiment;

FIG. 25 is a GUI screen according to the sixth embodiment;

FIGS. 26A and 26B are GUI screens according to the sixth embodiment; and

FIG. 27 is a flowchart of registration adjustment value update restriction processing according to the sixth embodiment.

### DESCRIPTION OF THE EMBODIMENTS

Embodiments will be described in detail below with reference to the accompanying drawings. The following embodiments are not intended to limit the invention according to the claims more than necessary. Although a number of features are described in the following embodiments, not all of these features are necessarily essential to solving the problems of the present disclosure, and the features may be combined in any way. Furthermore, the same or similar configurations are denoted by the same reference numerals in the accompanying drawings, and thus repeated description will be omitted as appropriate in this specification.

In this specification, the term “printing” (which may also be referred to as “print”) refers not only to the formation of meaningful information such as characters and graphics, but also to the formation of information, whether meaningful and meaningless. The term also refers to the formation of images, designs, patterns, and the like on a printing medium, regardless of whether they are manifested to be visible to human visual perception.

In addition, the term “printing medium” refers not only to printing paper used in general printing apparatuses, but also broadly to fabric, plastic film, metal plate, glass, ceramics, wood, leather, and the like that can accept ink. In the following embodiments, description will be given assuming that the printing medium is printing paper, but the technology disclosed herein is applicable not only to printing paper but also to other types of printing media. The term “printing apparatus” refers to an apparatus configured to perform printing on the printing medium described above. Examples of the printing apparatus include an ink jet printing apparatus.

Furthermore, the term “ink” (which may also be referred to as “liquid”) is broadly interpreted in the same manner as the definition of “printing” above. Therefore, “ink” refers to a liquid that can be applied onto a printing medium to form an image, design, pattern, and the like, or to process the printing medium, or refers to a liquid that can be used to process the ink (for example, to solidify or insolubilize a coloring material in the ink applied to the printing medium).

### First Embodiment

A first embodiment will be described in detail below with reference to the drawings.

### <Overview of Printing Apparatus>

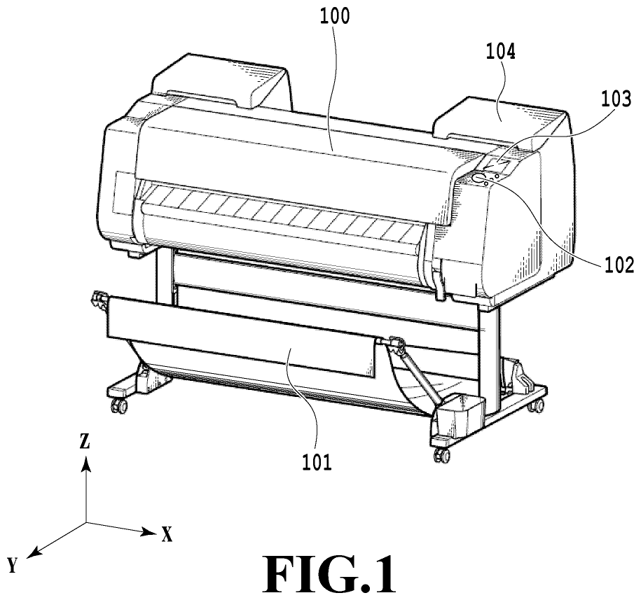

FIG. 1 is a perspective view showing an appearance of an ink jet printing apparatus (hereinafter abbreviated as “printing apparatus”) 100 according to the present embodiment, which uses 10 to 60 inch sized printing paper as a printing medium. It should be noted that, as mentioned above, the present embodiment can be applied to a printing apparatus configured to perform printing by ejecting ink onto any printing medium, and is not intended to limit the type and size of the printing medium.

The printing apparatus 100 shown in FIG. 1 includes a discharging guide 101 for stacking outputted printing paper, and an operation unit 102 configured to accept settings such as a printing mode and printing paper, and an operation to determine whether to execute adjustment functions executed by the printing apparatus. The operation unit 102 includes a display panel 103 for displaying various printing information and setting results, as well as reflections, warning display, and the like of the adjustment functions and test functions executed by the printing apparatus.

The printing apparatus 100 also includes an ink tank unit 104 that accommodates one or more ink tanks, such as black, cyan, magenta, and yellow, and supplies ink to a printing head.

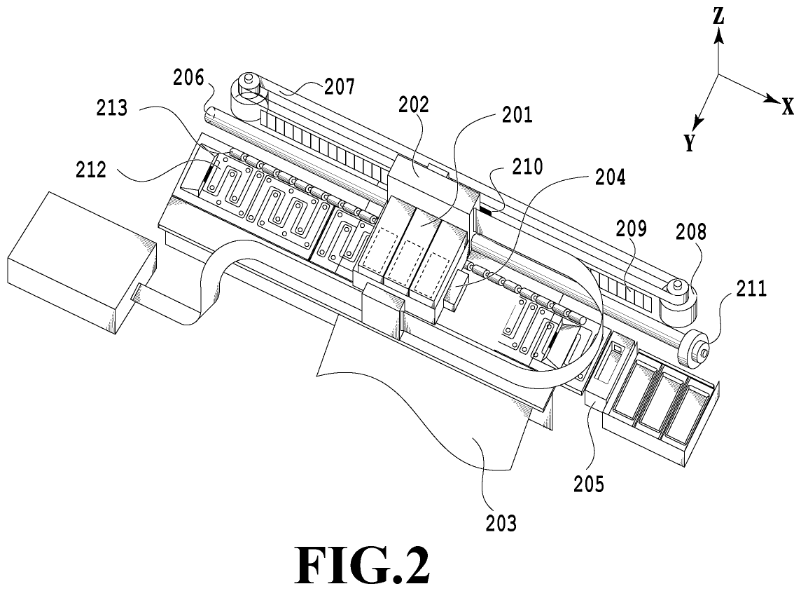

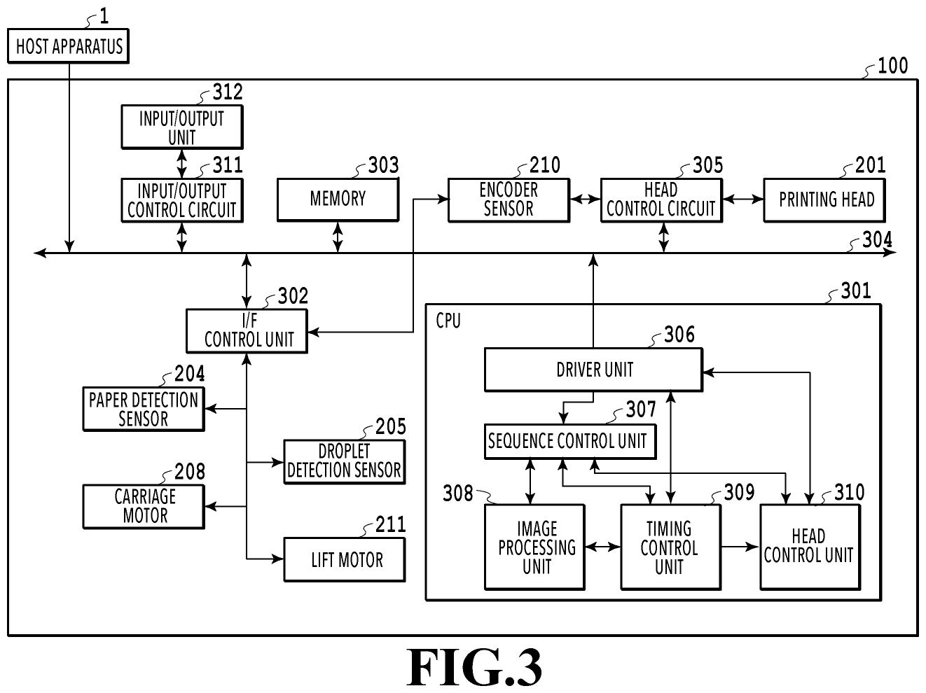

The printing apparatus according to the present embodiment may have a configuration in which a display panel 103 has a touch panel function that also serves as the operation unit 102 (in this case, the display panel 103 plays the role of an input/output unit 312 in FIG. 3). The printing apparatus according to the present embodiment may also have a function to display information on the display panel 103 in response to user operations from an external host apparatus such as an information processing apparatus (PC). Furthermore, as shown in FIG. 1, a scanning direction in which a carriage 202 (see FIG. 2) reciprocates is defined as an X direction, a conveyance direction of a printing paper 203 (see FIG. 2) is defined as a Y direction, and a height direction (vertical direction) is defined as a Z direction. This coordinate axis setting also applies to the other drawings.

FIG. 2 is a perspective view showing an internal configuration of the printing apparatus 100. A printing head 201 mounted on a carriage (hereinafter also abbreviated as “CR”) 202 includes a paper detection sensor 204 for detecting the distance between the printing paper 203 and the printing head 201. The ink tank unit 104 having one or more ink tanks is mounted on the CR 202 or the printing head 201.

The printing apparatus 100 also includes a droplet detection sensor 205 for detecting ink droplets ejected from the printing head 201. A main rail 206 supports the carriage 202 and restricts the movement direction of the carriage 202 to a horizontal direction (the X direction orthogonal to the Y direction, which is the conveyance direction of the printing paper), thus allowing the carriage to reciprocally scan along the horizontal direction.

The carriage 202 is driven by a carriage motor 208 via a carriage conveyance belt 207 to reciprocally scan in the horizontal direction. This structure allows the printing head 201 to move relative to the printing paper. An encoder sensor 210 mounted on the carriage 202 detects a linear scale 209 installed in the scanning direction (X direction) of the carriage 202 to obtain position information of the carriage 202. The printing apparatus 100 also includes a lift motor 211 for changing the height of the carriage 202 in stages. The lift motor 211 can move the printing head 201 closer to or away from the printing paper 203 by changing the height of the carriage 202.

The printing paper 203 is supported by a platen 212 and conveyed in the conveyance direction by a paper conveyance roller 213. Here, roll paper is used as an example of the printing paper, but the present embodiment is not limited to the roll paper. For example, cut paper may be used. The printing apparatus may also be configured to support a variety of printing paper widths.

FIG. 3 is a block diagram showing a control-related part of the internal configuration of the printing apparatus 100. The printing apparatus 100 includes a CPU 301, an I/F control unit 302, and a memory 303. The CPU 301 reads and executes programs stored in the memory 303 to control the entire apparatus. The I/F control unit 302 is controlled by the CPU 301, and controls a detection unit including the paper detection sensor 204, the droplet detection sensor 205, and the encoder sensor 210, as well as a drive unit including the carriage motor 208 and the lift motor 211. The memory 303 stores programs executed by the CPU 301 and various information used by the programs, such as the ejection speed and the thickness of the printing paper. The CPU 301, the I/F control unit 302, and the memory 303 are communicably connected to each other via a bus 304.

The I/F control unit 302 obtains information on the results of detection by the paper detection sensor 204 and the droplet detection sensor 205. The I/F control unit 302 also controls the carriage motor 208 that drives the carriage 202 to scan. The control I/F 302 also drives a head control circuit 305 based on the position information detected by the encoder sensor 210. In the configuration described above, printing data sent from a host apparatus 1 is converted into a head control signal, and the printing head 201 performs printing on the printing paper 203 based on the head control signal.

The CPU 301 reads and executes various programs stored in the memory 303 to function as a driver unit 306, a sequence control unit 307, an image processing unit 308, a timing control unit 309, or a head control unit 310. Note that, in the following description, the driver unit 306, the sequence control unit 307, the image processing unit 308, the timing control unit 309, and the head control unit 310 may be referred to as functional blocks without being differentiated from one another.

The sequence control unit 307 performs overall printing control, specifically, starting and stopping each functional block, controlling the conveyance of the printing paper, scanning control of the carriage 202, and the like.

The driver unit 306 controls the detection unit and the drive unit by outputting each control signal to the I/F control unit 302 via the bus 304 based on instructions from the sequence control unit 307. The driver unit 306 also obtains input signals from the detection unit and the drive unit via the I/F control unit 302 and the bus 304, and transmits the obtained input signals to the sequence control unit 307.

The image processing unit 308 performs image processing to separate or convert colors of input image data from the host apparatus 1. Here, the input image data from the host apparatus 1 is passed to the driver unit 306 via a communication unit (not shown) connected to the bus 304 or an input interface such as a universal serial bus (USB), and is then transmitted to the image processing unit 308.

The timing control unit 309 operates in conjunction with the carriage 202 or the printing head 201, and transmits the printing data generated by the conversion in the image processing unit 308 to the head control unit 310 according to the position of the carriage 202 or the printing head 201. The timing control unit 309 also controls ejection timing of the printing data for the printing head 201 based on the distance between the printing head 201 and the printing paper 203 detected by the paper detection sensor 204. The timing control unit 309 also controls the ejection timing based on the printing data for the printing head 201, using ejection speed information of ink droplets derived based on the timing of each ink droplet detected by the droplet detection sensor 205.

The head control unit 310 performs control to convert the printing data inputted from the timing control unit 309 into a head control signal and output the head control signal to the printing head 201, and to adjust the temperature of the printing head 201 based on an instruction of the sequence control unit 307. In other words, the head control unit 310 functions as an ejection control unit that controls the ink ejection by the printing head 201.

The input/output control circuit 311 is also connected to the I/F control unit 302 and the memory 303 to perform input control related to setting instructions for various functions, such as instructions to turn on the power or to execute printing, in accordance with instructions from a user. The input/output control circuit 311 also performs output control such as displaying on a screen system information on various apparatuses and contents related to the settings of various executable functions, and more specifically, performs control related to notification to the user based on data transmission and reception to and from the connected input/output unit 312. The input/output unit 312 may be a touch panel in which the operation unit 102 and the display panel 103 are integrated.

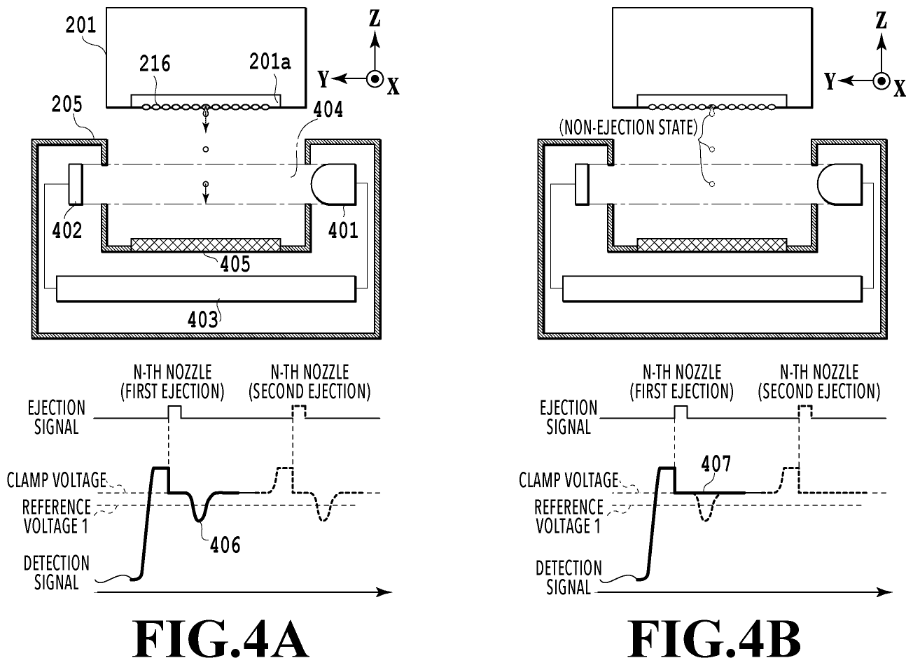

Next, with reference to FIGS. 4A and 4B, description will be given of a method for detecting ink droplets ejected from the printing head 201 and detecting the ejection state of an ejection port in the present embodiment. FIG. 4A shows an example of ink ejection in a case where the ejection port is in a normal state, that is, in a state where ejection from the ejection port is performed normally. FIG. 4B shows an example of ink ejection in a case where the ejection port is in a non-ejection state, that is, ejection is not performed normally.

The upper part of FIG. 4A and the upper part of FIG. 4B show cross-sectional views of the printing apparatus 100, and more specifically, cross-sectional views of the printing head 201 and the droplet detection sensor 205 taken along YZ plane. The YZ plane is a plane that passes through the Y direction and the Z direction. As shown in the upper parts of FIGS. 4A and 4B, the printing head 201 has ejection ports (hereinafter referred to as “nozzles”) 216 on an ejection port surface 201a, from which ink droplets are ejected for each ink color to form an image. The droplet detection sensor 205 includes a light emitting element 401, a light receiving element 402, a control circuit board 403, and a receiver 405. The light emitting element 401 is arranged so that the ink droplet ejected downward from the nozzle 216 passes through a light beam 404, and the light receiving element 402 is disposed at a position to receive the light beam 404 emitted from the light emitting element 401. In order to improve an S/N ratio by narrowing the light beam 404 incident on the light receiving element 402 from the light emitting element 401, an aperture is formed near each element, and the light receiving element 402 reads the amount of light beam 404 incident on the light receiving element 402 from the light emitting element 401.

A timing chart is shown at the bottom of FIGS. 4A and 4B. This timing chart shows the transmission timing of an ejection signal (instruction signal) to instruct ejection by applying a driving pulse to the printing head 201, and a detection signal of the light receiving element 402 that changes upon detection of ink droplets by the droplet detection sensor 205. The droplet detection sensor 205 includes the light emitting element 401, the light receiving element 402, the control circuit board 403, and the like. The light emitting element 401 emits the light beam 404, and the light receiving element 402 receives the light beam 404 emitted by the light emitting element 401. In the present embodiment, the light emitting element 401 and the light receiving element 402 are described as being disposed at different positions in the Y direction, but may be disposed at different positions in the X direction. That is, the light emitting element 401 may emit the light beam 404 in a direction intersecting the ejection direction (Z direction) of the nozzle 216, and the light receiving element 402 may be disposed at a position where the light beam 404 emitted by the light emitting element 401 can be received. The positional relationship between the light emitting element 401 and the light receiving element 402 is not limited to the example of FIGS. 4A and 4B. The light receiving element 402 outputs an output signal corresponding to the amount of light received to the control circuit board 403. This allows the control circuit board 403 to detect the amount of light received by the light receiving element 402.

On the control circuit board 403, there are provided a current-voltage conversion circuit for converting a current flowing according to the amount of light received by the light receiving element 402 into a voltage signal and outputting the voltage signal, and an amplifier circuit for amplifying the detection signal level of the ink droplets. The control circuit board 403 further includes a clamp circuit for holding the level of a signal outputted from the amplifier circuit at a predetermined value (clamp voltage) until ejection is detected. This makes it possible to suppress output saturation and a decrease in the S/N ratio caused by fluctuations in the level of the detection signal from the light receiving element 402 due to the influence of disturbance. By providing these circuits, a detection signal level due to predetermined ejection is ensured so that minute changes in the ejected ink droplets can be detected. In other words, the control circuit board 403 has a circuit element for detecting the output signal from the light receiving element 402, which changes with the ejection of ink droplets. Therefore, the amount of light received by the light receiving element 402 changes as the ink droplet passes through the light beam 404 of the droplet detection sensor 205. Based on the result of comparison between the level of the outputted detection signal and a predetermined reference voltage, it is determined whether or not the ejection state of the nozzle to be detected is normal.

The droplet detection sensor 205 is installed so that the light axis of the light beam 404 is at the same position in the Z direction as the surface of the platen 212 that supports the printing paper 203. Slits are provided near the light emitting element 401 and the light receiving element 402, respectively, to narrow the incident light beam 404 and improve the S/N ratio. The X-direction position of the printing head 201 at which ink droplets can be ejected so that the ink droplets pass through the light beam 404 is defined as the “detection position”. In a case of detecting ink droplets to detect the ejection state of each nozzle, the sequence control unit 307 controls the carriage motor 208 via the control I/F 302, and the printing head 201 moves to the detection position. If the printing head 201 is at the detection position, the printing head 201 is located vertically above the droplet detection sensor 205.

The detection position where the detection sensor detects droplets is set outside the range of the area through which the printing paper passes in the movement direction (X direction) of the carriage 202, as shown in FIG. 2. However, the detection position may be set within the range of the area through which the printing paper passes. In this case, the printing apparatus 100 performs processing such as cutting, conveying, and discharging the printing paper, and ejects ink droplets after the printing paper is no longer located at the detection position, so that the ink droplets can be detected.

A cross-sectional area of the light beam 404 in the XZ plane in the present embodiment is about 2 mm×2 mm=4² [mm²]. A parallel light projection area of the ink droplet in a case where the ink droplet passes through the light beam 404 is about 2-3 [mm²]. The ejection port array and the light beam 404 are arranged in a parallel relationship to each other, and the creepage distance in the height direction (Z direction) between the ejection port array and the light beam 404 is 2 to 10 mm. In a case where the creepage distance between the ejection port array and the light beam 404 is short, the passage of the ink droplet can be detected with the light beam 404 in a close position with respect to the flying distance of the ejected ink droplet, thus making it possible to stably detect the ejection state. However, with the ejection port array and the light beam 404 being close to each other, a diffusion light component emitted from the light emitting element 401 is reflected by the ejection port surface 201a of the printing head 201, and a light amount component received by the light receiving element 402 is generated. As a result, there is a possibility that the light amount component is superimposed on the detection signal as a noise component during the detection of the ejection state, reducing the detection accuracy. To deal with this, the creepage distance between the light beam 404 in the droplet detection sensor 205 and the ejection port array on the printing head 201 is set taking into consideration the correlative relationship between the light beam 404 and the ejection port array. Additionally, it is necessary to match the conditions during the detection of the ink droplet by the droplet detection sensor 205 with the conditions during the ejection of the ink droplet onto the printing paper 203 during printing (image formation). Therefore, the light beam 404 and the platen 212 supporting the printing paper 203 are each arranged at substantially the same position (height) as during printing (image formation) in the Z direction.

Next, with reference to FIGS. 4A and 4B, description will be given of a configuration for detecting the nozzle ejection state, specifically, determining whether it is in the normal state or non-ejection state.

The lower diagram of FIG. 4A is a graph showing a detection result in a case where a nozzle (here, an “N-th nozzle”) approximately in the center of the Y direction, among the plurality of nozzles 216, as a target nozzle for detection of the state by the droplet detection sensor 205 can normally eject.

The head control unit 310 and the head control circuit 305 in the CPU 301 cause the ink droplet to be ejected toward the droplet detection sensor 205 based on the ejection signal. The control signal synchronized with the ejection of the ink droplet operates the above-described clamp circuit to maintain the level of the signal to be outputted at a predetermined clamp voltage value immediately before detecting the ejection of the ink droplet. Thereafter, the ejection of the ink droplet is started, and the CPU 301 stops the operation of the clamp circuit immediately before the ink droplet ejected toward the light beam 404 blocks the light. The CPU 301 also determines the ejection state of the target nozzle (N-th nozzle) based on a reference voltage value that is predetermined based on the amount of change as the ink droplet blocks the light beam 404 and a signal value changed as the ejected ink droplet passes through the light beam 404 of the droplet detection sensor 205. Specifically, the target nozzle (N-th nozzle) is determined to be in the normal state as the signal value smaller than the reference voltage value is detected. Note that FIG. 4A shows a case where the ejection from the target nozzle is performed multiple times in order to obtain a more reliable result regarding the detection result of ink ejection from the target nozzle by the droplet detection sensor 205.

The lower diagram of FIG. 4B is a graph showing a detection result in a case where a nozzle (here, an “N-th nozzle”) approximately in the center of the Y direction, among the plurality of nozzles 216, as a target nozzle for detection of the state by the droplet detection sensor 205 cannot normally eject (that is, the non-ejection state). As in FIG. 4A, the head control unit 310 and the head control circuit 305 in the CPU 301 cause the ink droplet to be ejected toward the droplet detection sensor 205 based on the ejection signal. In this case, however, the ink droplet is not ejected normally, resulting in an insufficient ejection state. As a result, the ink droplet cannot block the light beam 404, and the reduction in the amount of light that occurs during normal ejection of the ink droplet is not obtained. Therefore, the signal value of the detection signal does not fall below the reference voltage value after exceeding the clamp voltage value even if the ejection of the ink droplet is instructed. In such a case, the CPU 301 determines that the target nozzle (N-th nozzle) is in a non-ejection state.

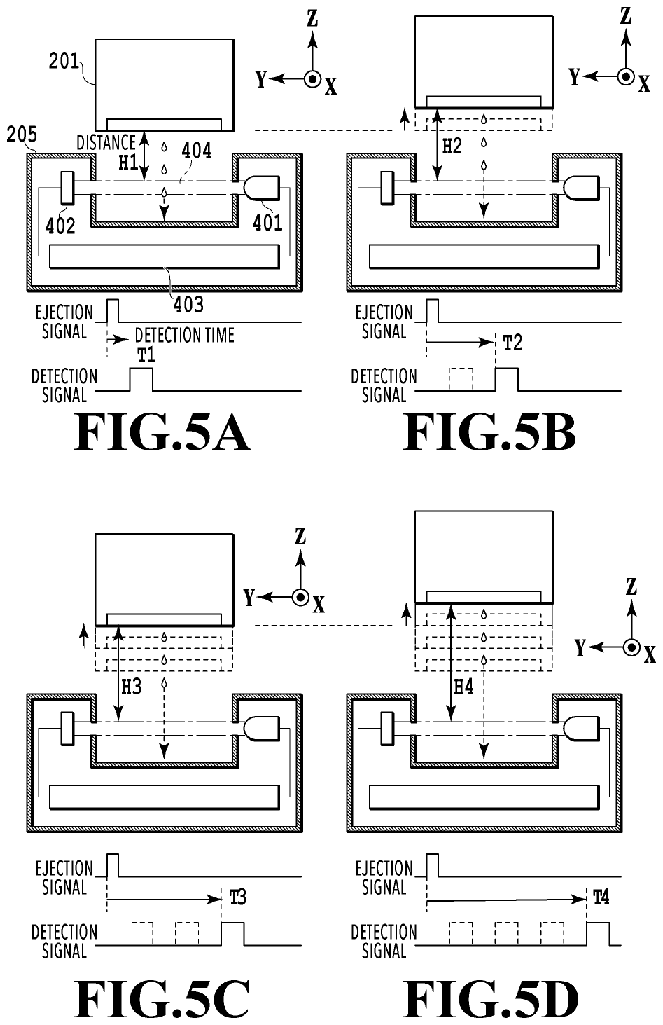

FIG. 5A is a diagram showing an internal configuration of the droplet detection sensor 205 for detecting the ejection speed of ink droplets ejected from the printing head 201. The CPU 301 drives the lift motor 211 to set a state where the printing head 201 and the droplet detection sensor 205 are spaced apart by a predetermined distance, causes the ink droplet to be ejected in this state, and detects the ejected ink droplet. Note that the distance between the printing head 201 and the droplet detection sensor 205 (more specifically, the light beam 404) in FIG. 5A is defined as a “first distance H1”.

A method for detecting ejected ink droplets and calculating the speed of the ink droplets in the present embodiment will be described in detail. In the configuration shown in FIG. 5A, the head control unit 310 and the head control circuit 305 in the CPU 301 cause the ink droplet to be ejected from the printing head 201 toward the droplet detection sensor 205 based on an ejection signal. In this event, the timing at which the amount of light changes as the ink droplet passes through the light beam 404 is used. Specifically, a detection time (first detection time T1) between the generation of the ejection signal and the output of the detection signal is obtained as the detection time corresponding to the first distance H1 from the printing head 201 to the droplet detection sensor 205.

FIG. 5B shows a state where the lift motor 211 is driven to further increase the distance between the printing head 201 and the droplet detection sensor 205, compared to the state of FIG. 5A. The distance between the printing head 201 and the droplet detection sensor 205 in this state is defined as a “second distance H2”.

In FIG. 5B, again, the timing at which the amount of light changes as the ink droplet passes through the light beam 404 is used, as in FIG. 5A. Specifically, a detection time (second detection time T2) between the generation of the ejection signal and the output of the detection signal is obtained as the detection time corresponding to the second distance H2 from the printing head 201 to the droplet detection sensor 205.

As for FIGS. 5A and 5B, a first ejection speed V1 of the ink droplet is calculated as shown in Formula (1) based on a distance difference between the first distance H1 and the second distance H2 and a time difference between the first detection time T1 and the second detection time T2.

$$V 1 = ( H 2 - H 1 ) / ( T 2 - T 1 ) \qquad Formula ( 1 )$$

FIG. 5C shows a state where the lift motor 211 is driven to further increase the distance between the printing head 201 and the droplet detection sensor 205, compared to the state of FIG. 5A or 5B. The distance between the printing head 201 and the droplet detection sensor 205 in this state is defined as a “third distance H3”.

In FIG. 5C, again, the timing at which the amount of light changes as the ink droplet passes through the light beam 404 is used, as in FIG. 5A. Specifically, a detection time (third detection time T3) between the generation of the ejection signal and the output of the detection signal is obtained as the detection time corresponding to the third distance H3 from the printing head 201 to the droplet detection sensor 205.

As for FIGS. 5B and 5C, as in the case of the first ejection speed V1, a second ejection speed V2 of the ink droplet is calculated as shown in Formula (2) based on a distance difference between the second distance H2 and the third distance H3 and a time difference between the second detection time T2 and the third detection time T3.

$$V 2 = ( H 3 - H 2 ) / ( T 3 - T 2 ) \qquad Formula ( 2 )$$

FIG. 5D shows a state where the lift motor 211 is driven to further increase the distance between the printing head 201 and the droplet detection sensor 205, compared to the states of FIGS. 5A to 5C. The distance between the printing head 201 and the droplet detection sensor 205 in this state is defined as a “fourth distance H4”.

In FIG. 5D, again, the timing at which the amount of light changes as the ink droplet passes through the light beam 404 is used, as in FIG. 5A. Specifically, a detection time (fourth detection time T4) between the generation of the ejection signal and the output of the detection signal is obtained as the detection time corresponding to the fourth distance H4 from the printing head 201 to the droplet detection sensor 205.

Here, as for FIGS. 5C and 5D, as in the case of the first ejection speed V1, a third ejection speed V3 of the ink droplet is calculated as shown in Formula (3) based on a distance difference between the third distance H3 and the fourth distance H4 and a time difference between the third detection time T3 and the fourth detection time T4.

$$V 3 = ( H 4 - H 3 ) / ( T 4 - T 3 ) \qquad Formula ( 3 )$$

As described above, the ejection speed of the ink droplet is calculated based on the time difference between the detection times of the ink droplets as the distance between the printing head 201 and the droplet detection sensor 205 changes.

The configuration described above also makes it possible to further increase the distance between the printing head 201 and the droplet detection sensor 205 by driving the lift motor 211. Therefore, it is possible to measure even more separation distances (distances between the printing head 201 and the droplet detection sensor 205) and the detection times corresponding to each of these distances. The ejection speed of the ink droplet can thus be calculated with higher accuracy. On the other hand, it is also possible to shorten the time required to calculate the ejection speed of the ink droplet by reducing the distance by which the printing head 201 and the droplet detection sensor 205 are separated by the lift motor 211, or by reducing the number of times the separation is performed.

As described above, the printing apparatus 100 of the present embodiment includes an elevating and lowering unit for changing the distance from the printing head 201 to the droplet detection sensor 205 in multiple stages, and calculates the ejection speed of the ink droplet corresponding to each stage. This configuration makes it possible to provide a detection unit capable of detecting the nozzle ejection state with high accuracy.

The nozzle ejection state may change as ink droplets are repeatedly ejected. On the other hand, changes caused by ejecting ink droplets several times are extremely small and negligible. Therefore, as a guideline, it is sufficient to monitor the ejection state about once per printing of several pages.

As an example, the head control unit 310 may count the number of ejections from each of the plurality of nozzles 216, and set the nozzle 216 whose dot count exceeds a predetermined threshold as a target nozzle to be monitored to determine the ejection state before printing on the printing paper. The counted number of ejections is called the dot count (value). The ejection state determination may be performed after receiving an instruction to perform printing and before printing on the printing paper.

As another example, in a case where printing is performed across multiple pages, influences on the printing on the printing paper can be reduced by monitoring the ejection state during the conveyance of the printing paper between pages or between scans of the printing head 201.

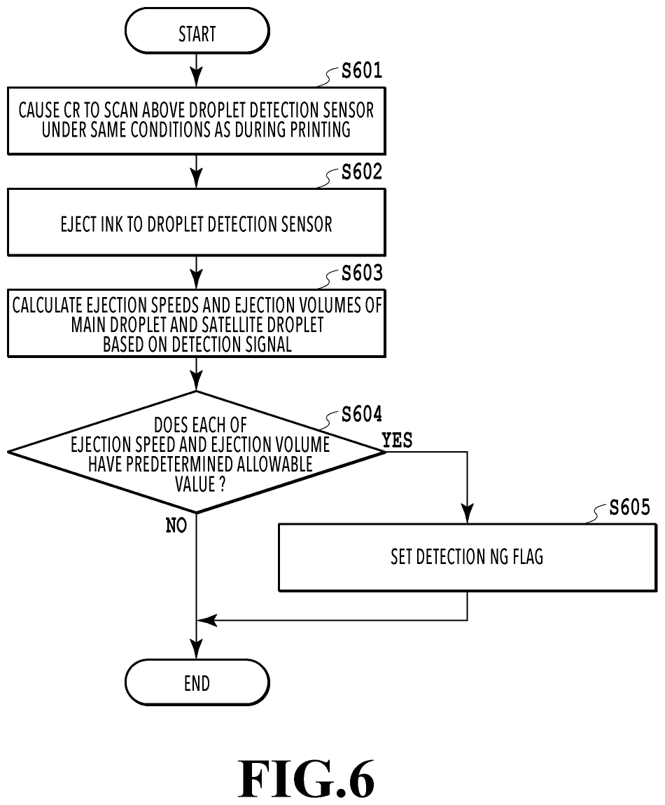

FIG. 6 shows a flowchart of processing of detecting the nozzle ejection state, which is performed by the printing apparatus 100 according to the present embodiment. A series of processing shown in FIG. 6 is executed by the CPU 301 according to a program stored in the memory 303 as a predetermined time elapses or as the dot count corresponding to the total number of ejections from all nozzles exceeds a predetermined threshold. Alternatively, it is also conceivable to execute the processing immediately after a nozzle cleaning operation, in order to determine the change of state with high accuracy in a stable state of the nozzles.

If either the ejection speed or the ejection volume changes by a certain amount or more, there is a possibility of affecting an image. Therefore, by comparing with a threshold value (preset) used to determine whether image quality may be deteriorated, the CPU determines whether the amount of change is greater than the threshold for each of the ejection speed and ejection volume.

In step S601, the CPU 301 causes the CR 202 to scan under the same conditions as during printing and pass over the droplet detection sensor 205. Note that, for simplicity, “Step S” will be hereinafter abbreviated as “S”.

In S602, the CPU 301 causes ink droplets to be ejected toward the droplet detection sensor 205 so that the ink droplets pass through the light beam 404.

The “same conditions as during printing” means that the driving conditions of the CR 202 and the printing head 201 in S601 use the same parameters as the driving conditions of the CR 202 and the printing head 201 during printing. The driving conditions of the CR 202 include parameters such as the carriage height and the carriage driving speed. There are three types of driving speed: a speed for an acceleration region where the carriage moves at an accelerated speed, a speed for a constant speed region where the carriage moves at a constant speed, and a speed for a deceleration region where the carriage moves while decelerating. Considering that the printing is mostly performed in the constant speed region, the ejection monitoring is performed in the constant speed region. In the present embodiment, the deceleration region is a region where the acceleration of the CR 202 is less than a negative predetermined value a1, the acceleration region is a region where the acceleration of the CR 202 is greater than or equal to a positive predetermined value a2, and the constant speed region is a region where the acceleration of the CR 202 is greater than or equal to a1 but less than a2. The speed of the CR 202 in the constant speed region may be a single value within a predetermined range. The driving conditions of the printing head 201 include parameters such as block driving and ejection pulse width.

To monitor changes in the landing state of droplets ejected onto the printing paper, the CR 202 is driven under the same conditions as those during printing. These conditions include the distance (carriage height) between the CR 202 and the printing paper, the scanning speed of the CR 202, and the like.

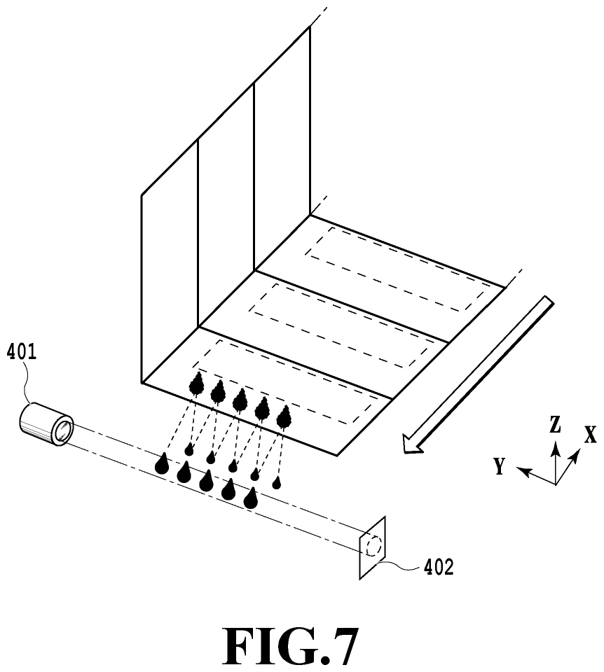

FIG. 7 is a conceptual diagram of droplet detection performed while driving the CR. Depending on the conditions during ejection, ink droplets ejected from the printing head 201 are ejected separately into main droplets and small droplets other than the main droplets (referred to as satellite droplets or satellites in this specification). The main droplets and satellite droplets are ejected from the same nozzle 216, but the landing positions thereof on the printing paper may differ due to a difference in ejection speed. In order to detect changes in the landing position on the printing paper and changes in the landing dot shape, ejection monitoring is performed under the same conditions as during printing. In the present embodiment, the same conditions as those used during printing are used, but the conditions do not necessarily need to match in order to detect changes in the ejection state, and driving conditions different from those used during actual printing may be used.

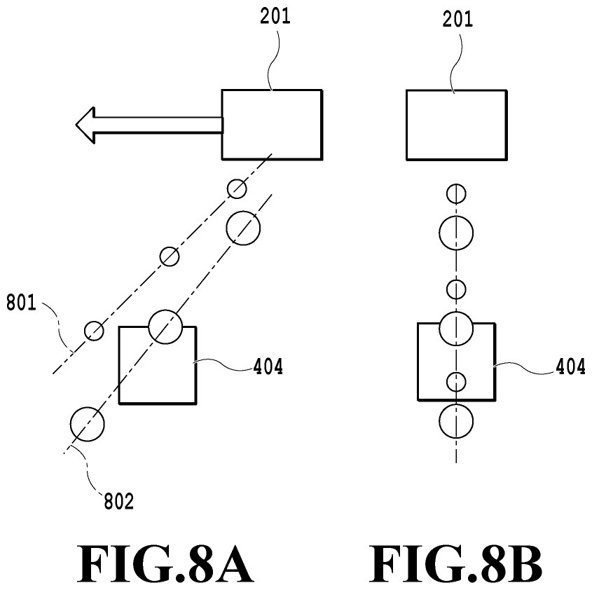

Here, as for the droplet detection while driving the CR, a difference between ejection in a state where the CR is driven and ejection in a state where the CR is not driven will be additionally described with reference to FIGS. 8A and 8B. FIG. 8A shows ejected droplets and the detection unit in a case of performing droplet detection while driving the CR 202. FIG. 8B shows ejected droplets and the detection unit in a case of performing droplet detection with the CR 202 stopped.

As described above, the droplets ejected from the nozzle 216 include a main droplet and a satellite droplet. The main droplet and the satellite droplet differ in ejection volume and ejection speed. Specifically, the ejection speed of the satellite droplet is slower than that of the main droplet. That is, the main droplet is larger than the satellite droplet in moving distance per unit time in the vertical direction (Z direction). On the other hand, the main droplet and the satellite droplet are equal in moving distance in the movement direction (+X direction or −X direction) of the CR 202. For this reason, in a case of performing droplet detection while driving the CR 202, the main droplet flies along a trajectory 802 with a different inclination in the XZ plane from a trajectory 801 along which the satellite droplet flies. The head control unit 310 controls the ejection timing so that one of the trajectories 801 and 802 passes through the light beam 404 (that is, the droplet detection range), thus making it possible for the CPU 301 to know the detection timing separately between the main droplet and the satellite droplet.

On the other hand, as shown in FIG. 8B, in a case of ejecting ink in a state where the CR 202 is not driven, a trajectory along which the satellite droplet flies coincides with a trajectory along which the main droplet flies. For this reason, the main droplet and the satellite droplet cannot be detected separately.

By thus performing ink ejection and droplet detection while driving the CR 202, it is possible to derive changes in ejection volume and ejection speed of the ejected main droplet, as well as changes in ejection volume and ejection speed of the ejected satellite droplet. Although the example of FIG. 8A shows the trajectory 802 passing through the irradiation range of the light beam 404 to detect the main droplet, it is also possible to implement a method of shifting the ejection timing and detecting the satellite droplet only.

It is also possible to separate the signals by passing the main droplet and the satellite droplet together through the detection unit and differentiating the timing of detection by the detection unit. In this case, ink may be ejected in the state where the CR 202 is not driven, as shown in FIG. 8B.

Referring back to FIG. 6, in S603, the CPU 301 calculates the ejection speed and ejection volume of the main droplet as well as the ejection speed and ejection volume of the satellite droplet based on the detection signal from the light receiving element 402.

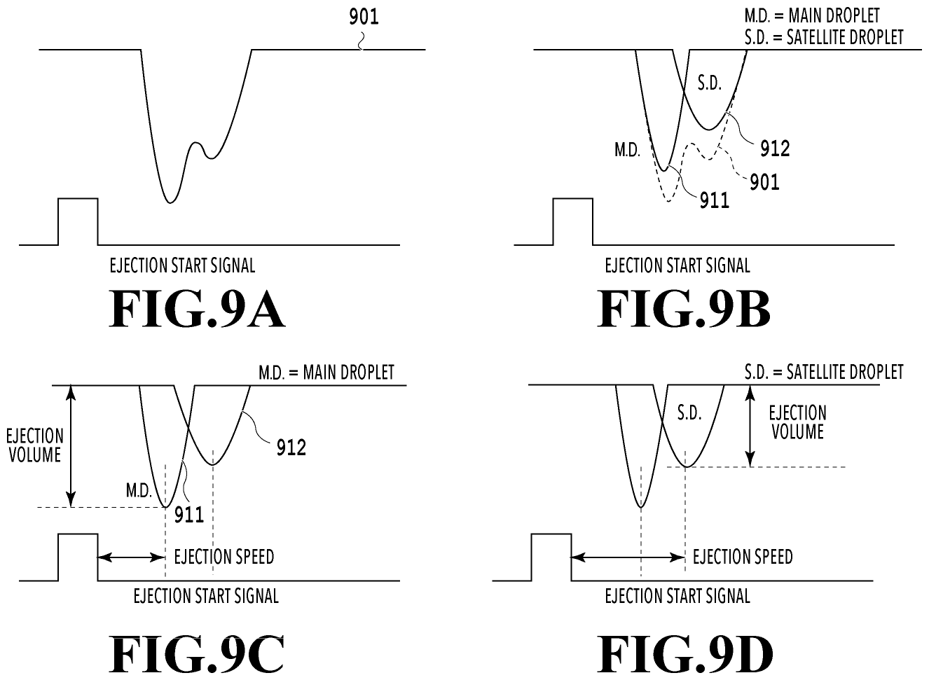

As described above with reference to FIG. 4A, the output signal from the light receiving element 402 changes according to the amount of light received by the light receiving element 402. Therefore, the output signal from the light receiving element 402 changes as the droplet passes through the light beam 404. FIGS. 9A and 9B are schematic diagrams for calculating the ejection speed and ejection volume according to the present embodiment. FIG. 9A shows an output signal (detection signal 901) from the light receiving element 402, which changes according to the amount of light received by the light receiving element 402. The signal that changes as the main droplet and the satellite droplet pass through the light beam 404 affects the distribution of droplets that pass through the light beam 404. A change in ejection speed is correlated with the number of ejections performed for printing from each nozzle 216. Therefore, in a case of using droplets ejected from the plurality of nozzles 216 for detection, the distribution of the ejection speed is less biased by selecting the nozzles 216 with similar numbers of ejections.

In the example shown in FIG. 9B, function approximation is performed assuming that the ejection speeds of the main droplet and the satellite droplet comply with a normal distribution. Since the main droplet always has an ejection speed greater than or equal to that of the satellite droplet, a front-side waveform on the time axis, in two normal distribution results, is considered as the waveform of the main droplet, and the other is considered as the waveform of the satellite droplet. As an example, the CPU 301 may detect a minimum value in a predetermined period after transmission of an ejection start signal, and determine that the front-side minimum value on the time axis corresponds to the main droplet waveform, and the second minimum value on the time axis corresponds to the satellite droplet waveform. As another example, the CPU 301 may determine that the detection amount in a predetermined range on the time axis represents a waveform corresponding to the main droplet. This is because the main droplet is a droplet of a predetermined size or larger, and is always detected within a predetermined time.

Using the method described above, the CPU 301 can separate a normal distribution 911 obtained by approximating the detection amount of the main droplet from a normal distribution 912 obtained by approximating the detection amount of the satellite droplet, based on the detection signal 901. However, the function approximation does not necessarily have to be performed using a normal distribution, but may be performed using a polynomial. In this case, the results of the function approximation such as the normal distribution 911 for the main droplet and the normal distribution 912 for the satellite droplet are called an approximation function for the main droplet and an approximation function for the satellite droplet, respectively.

Note that a peak fitting method is known as a method for separating detection signals. This is a method in which a peak value and a half width are given to a Gaussian function or a Lorentz function, and calculations are repeated until a composite spectrum of the waveforms calculated with each function matches an actual spectrum. For example, in a case where a detection signal of a main droplet alone or a detection signal of a satellite droplet alone can be approximated by a Gaussian function, the waveforms can be separated as shown in FIG. 9B with the peak fitting method using the Gaussian function. After the waveforms are separated, the ejection speed and the ejection volume can be calculated for each of the detection signal of the main droplet and the detection signal of the satellite droplet, based on a time difference from the ejection start signal to the peak and the peak value.

The approximation function of the detection signal is not limited to the Gaussian function, but may be a Lorentz function or a polynomial function. The method for approximating and separating the detection signal is not limited to the peak fitting method, but may be a non-linear least-squares method.

FIG. 9C is a conceptual diagram showing how the ejection speed and ejection volume of the main droplet are calculated using the waveform of the main droplet obtained by separating the detection signal. The CPU 301 calculates the time between the ejection start and detection of the ink droplet, based on the approximation function described with reference to FIG. 9B. Since the distance between the CR 202 and the droplet detection sensor 205 is known, the ejection speed of the main droplet can be calculated based on the time between the ejection start and detection of the ink droplet and the distance. In ejection monitoring here, a difference is detected between the time between the ejection start and detection of the ink droplet calculated this time and the time between the ejection start and detection of the ink droplet calculated last time. Therefore, if the set distance between the CR 202 and the droplet detection sensor 205 is the same as that from the previous detection, the CPU 301 does not need to know the exact absolute value of the distance. For example, if the initial ejection speed of 18 m/s is obtained, high detection accuracy is not required for 18 m/s itself, but it is sufficient to accurately detect a change of 0.5 m/s as the amount of change after using the nozzle to a certain extent. The CPU 301 may also derive (calculate) the ejection volume from the amount of change in the separated detection signal. This ejection volume can be derived based on the correspondence between the amount of change in the detection signal of the light receiving element 402 and the ejection volume. This correspondence is predefined.

FIG. 9D is a conceptual diagram showing how the ejection speed and ejection volume of the satellite droplet are calculated using the waveform of the satellite droplet obtained by separating the detection signal. The CPU 301 can calculate the ejection speed and ejection volume of the satellite droplet in the same way as the main droplet. Here, in a case where the ejection speed from the nozzle 216 changes, the landing position of the droplet on the printing paper is shifted. In that case, in printing one vertical line, for example, printing failure may occur, such as line thickening, one line turning into two lines, or shifted position of the line. Similarly, in a case where the size of the droplets changes, the density of dots formed on the printing paper changes. For example, in a case of forming an image by superimposing magenta and cyan, a change in droplet size of one nozzle changes the color density balance, which may cause printing failure. The CPU 301 calculates the ejection speed and ejection volume based on the detection value from the droplet detection sensor 205.

In S604, the CPU 301 determines whether the droplet ejection speed and ejection volume calculated in S603 each have a predetermined allowable value. If the determination result in this step is true, it is determined that there is a change in the ejection state, and the processing proceeds to S605. On the other hand, if the determination result in this step is false, it is determined that there is no change in the ejection state, and the series of processing ends. In principle, the determination in this step is performed for both the main droplet and the satellite droplet, but may be performed for the main droplet only.

For example, the CPU 301 determines whether or not the calculated ejection volume is greater than or equal to a first threshold value associated with the ejection volume, and if not, determines that the ejection volume does not have the predetermined allowable value (YES in S604). The CPU 301 also determines whether or not the calculated ejection speed is greater than or equal to a second threshold value associated with the ejection speed, and if not, determines that the ejection speed does not have the predetermined allowable value (YES in S604). If the calculated ejection volume is greater than or equal to the first threshold value and the calculated ejection speed is greater than or equal to the second threshold value, the ejection speed and ejection volume of the droplet are each determined to have the predetermined allowable value (NO in S604). Note that only one of the ejection volume and the ejection speed may be compared with a threshold value to determine whether it has an allowable value.

In S604, it may be determined whether or not the amount of change in ejection volume as compared to the past detection results is less than or equal to a third threshold value associated with the amount of change in ejection volume. Similarly, it may be determined whether or not the amount of change in ejection speed as compared to the past detection results is less than or equal to a fourth threshold value associated with the amount of change in ejection speed. In a case of performing this processing, the past detection results are recorded in the memory 303. If the amount of change in the ejection volume is less than or equal to the third threshold value and the amount of change in the ejection speed is less than or equal to the fourth threshold value (NO in S604), the CPU 301 determines that there is no change in the ejection state and ends the series of processing. On the other hand, if the change in the ejection volume is greater than the third threshold value or the change in the ejection speed is greater than the fourth threshold value (YES in S604), the CPU 301 determines that there is a change in the ejection state and proceeds to S605. The CPU 301 can thus determine whether or not there is a change in the ejection state by comparing the initial or past ejection state with the current ejection state.

As described above, for each of the main droplet and the satellite droplet, the calculated values of the ejection speed and ejection volume are compared with the predetermined threshold values (first and second threshold values). If any one of them falls below the predetermined threshold value, there is a possibility of affecting the printing processing. For each of the main droplet and the satellite droplet, the change in the ejection speed and the change in the ejection volume are compared with the predetermined threshold values (third and fourth threshold values). If those changes exceed the predetermined threshold values, again, there is a possibility of affecting the printing processing. For this reason, in S605, the CPU 301 sets a flag value of a detection NG flag stored in the memory 303 to ON, and ends the series of processing. The “detection NG flag” is a flag indicating that the ejection state of the printing head 201 is not detected to be normal. In the present embodiment, the ejection state of the nozzle is evaluated on a two-point scale of OK and NG, but may be evaluated into three or more grades (for example, four grades of excellent, good, fair, and poor) by using more threshold values.

Additionally, in S605, recovery processing of the printing head 201 may be automatically performed. The recovery processing includes continuous ejection into a cap (not shown) multiple times, such as 1000 times or more, for example, 10,000 times. The recovery processing may further include suctioning the nozzle 216 with the cap, or may include cleaning processing such as wiping the nozzle 216, or foreign substance removal processing using an electric potential. By detecting the ejection state again in the same manner as described above after the execution of such recovery processing, it is possible to determine whether the ejection state is recovered by the recovery processing.

In the present embodiment, the first to fourth threshold values described above used as reference values for the ejection state are described as values prestored in the memory 303 at the time of product manufacture. However, the first to fourth threshold values may be updated based on the detection results from the droplet detection sensor 205, for example. For example, a new first or second threshold value may be stored in the memory 303 for the ejection speed or ejection volume that is determined to be greater than or equal to the predetermined threshold value, from among the ejection speeds and ejection volumes calculated in S603.

As the reference values (first to fourth threshold values) of the ejection speed and ejection volume stored in the memory 303, the ejection speed and the ejection volume during adjustment of the printing apparatus, specifically after registration adjustment processing or density adjustment processing may be used. The ejection speed and the ejection volume after such adjustment are derived and stored in the memory 303. Thereafter, comparison is made with the above starting point (that is, the starting point at which the registration adjustment or density adjustment is performed) at the timing detected in the ejection monitoring. The starting point is updated as the registration adjustment or density adjustment is performed. In this specification, the registration adjustment is also referred to as landing position adjustment. The density adjustment is also referred to as color calibration.

Furthermore, in S605, the CPU 301 may notify the user of the change in the ejection state. In this case, the CPU 301 may send a message to the user or an administrator via a network to prompt the adjustment of the ejection state, or may display the message on the display panel 103 of the printing apparatus 100.

In S605, the CPU 301 may also execute registration adjustment processing based on the detection result. For example, if there is no change in the ejection volume but there is a change in the ejection speed, only the landing position on the printing paper changes. In this case, the CPU 301 may be able to respond to the change in the ejection state by changing the ejection timing. Therefore, the CPU 301 adjusts the registration for determining the ejection timing for ejecting at the landing position. The CPU 301 may also execute density adjustment in the printing processing of the printing apparatus 100. The CPU 301 may also adjust a pulse width of a driving pulse applied to the printing head 201. The CPU 301 may further execute processing to change the distance between the printing head 201 and the printing paper in the printing processing of the printing apparatus 100. In other words, different processing may be executed in S605 depending on the changed ejection state.

One method to perform automatic adjustment upon detection of a change in the ejection state is to adjust the landing position is conceivable. This can be realized by printing on the printing paper and detecting the printed pattern. Another method is to adjust the ejection timing based on a shift amount of the landing position. The shift amount of the landing position caused by a change in the ejection speed can be derived based on the distance between the head and the paper, the carriage scanning speed, and the ejection speed. By adopting these methods, the amount of paper waste can be reduced.

The operation of causing the CR 202 to scan under the same conditions as during the printing operation and pass over the ejection monitoring sensor, as described in S601 of FIG. 6, will be additionally described below.

The ejection monitoring sensor has a different optical system configuration and a different objective function to be realized from the droplet detection sensor 205. The ejection monitoring sensor may be provided separately from the droplet detection sensor 205 shown in FIG. 2. However, from the viewpoint of the number of hardware components, it is preferable that the droplet detection sensor 205 also serves as the ejection monitoring sensor. In that case, the ejection monitoring is performed using the droplet detection sensor 205 disposed outside the printing area where printing is performed on the printing paper.

On the other hand, the ejection monitoring can be performed by the ejection monitoring sensor during the printing operation. In this case, the movement of the CR 202 to the droplet detection sensor 205 disposed outside the printing area can reduce throughput of the printing processing. For this reason, a preliminary ejection port disposed closest to the printing area may be used as an ink ejection destination used in ejection monitoring by the ejection monitoring sensor. The “preliminary ejection port” is originally the ink ejection destination used in preliminary ejection. By arranging the ejection monitoring sensor in the passage area during printing, the ejection monitoring can be performed without reducing the throughput of the printing processing.

As a droplet passes the ejection monitoring sensor, in a case where the droplet is split into a main droplet and a satellite droplet, the main droplet and the satellite droplet block the light beam a short time after the main droplet alone blocks the light beam. As a result, the detection signal from the ejection monitoring sensor has a waveform with two peak values (local minimum values) as shown in FIG. 9A. Such a detection signal can be interpreted as a composite signal in which the detection signal of the main droplet and the detection signal of the satellite droplet are combined. In order to calculate the ejection speed and the ejection volume of each of the main droplet and the satellite droplet, the composite signal needs to be separated into a detection signal of the main droplet and a detection signal of the satellite droplet.

Here, additional description will be given of the determination in S604 as to whether or not the ejection speed and the ejection volume of the droplet calculated in S603 are within a predetermined range, in other words, whether or not there is a change in the ejection state. The purpose of the ejection monitoring is to detect a change from the ejection state determined to be normal. Possible starting point states determined to be normal include a state at the time of initial installation of the printing apparatus 100 and a state at the time of shipment. In addition, other starting point states include a state immediately after replacing the printing head 201, a state after the landing position adjustment processing (registration adjustment processing), and the like. In these states, the ejection state is detected, and a value thus detected is stored as a parameter indicating a predetermined ejection state. The ejection state is determined to be abnormal as the amount of change from the predetermined ejection state is greater than or equal to a certain amount.

As described above, according to the present embodiment, the ejection state of the nozzles of the printing apparatus can be detected with high accuracy, and thus the ejection state can be accurately monitored. This makes it possible to prevent printing failure caused by aging (deterioration) or unintended changes in ejection.

### Second Embodiment

In the present embodiment, in a case where it is determined that there is a change in the ejection state based on the derived ejection speed and ejection volume, the printing apparatus executes processing according to mode setting selected by the user.

The user can display the contents of the currently set mode setting and selectively change these contents by operating the input/output unit 312 (see FIG. 2) of the printing apparatus. Alternatively, the user may change the contents of the mode setting using software installed in the host apparatus 1 such as a PC, instead of operating the input/output unit 312.

### <Processing of Setting Control Processing Mode>

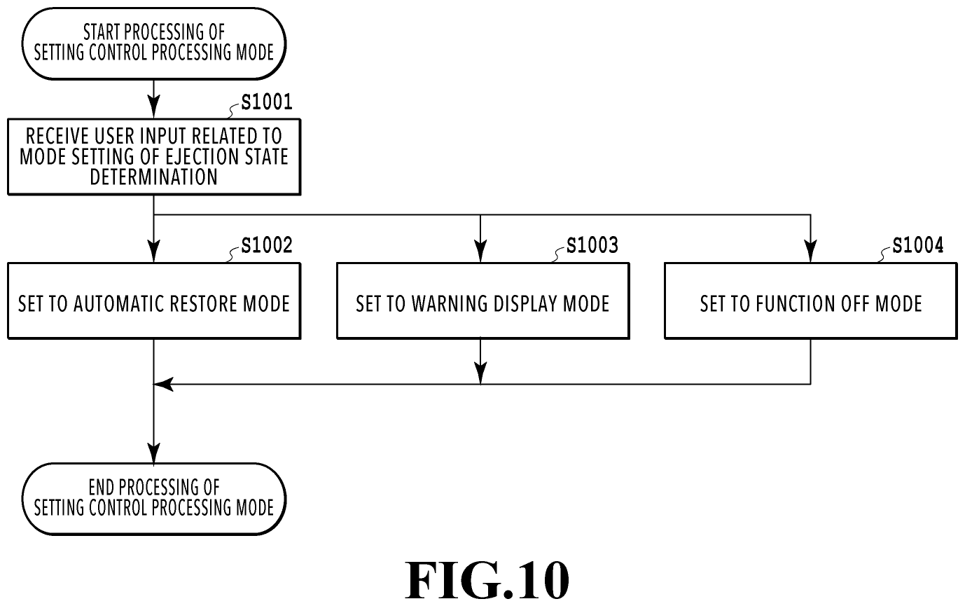

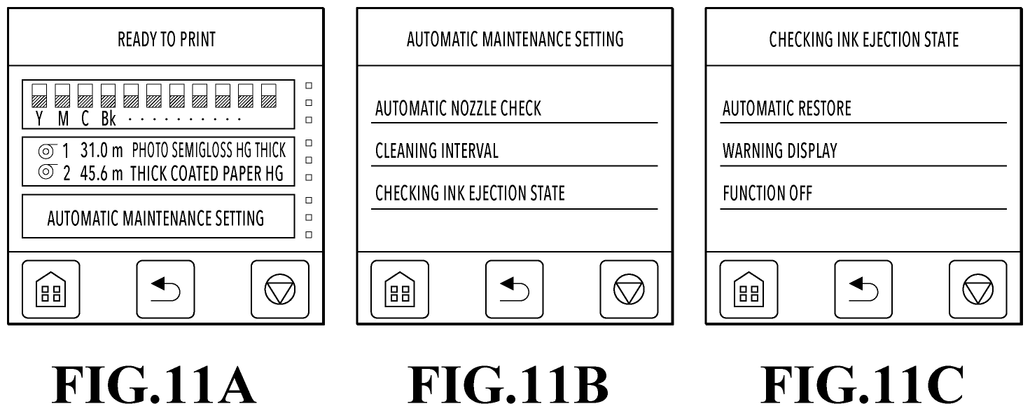

If it is determined in the detection processing (see FIG. 6) according to the first embodiment that there is a nozzle in a non-ejection state, the printing apparatus of the present embodiment performs control processing corresponding to a mode preset by the user. FIG. 10 is a flowchart of processing to preset the above-mentioned mode (referred to as the control processing mode). Each step of FIG. 10 is executed by the CPU 301 according to a program stored in the memory 303. The processing of FIG. 10 is usually triggered by the user arbitrarily operating the input/output unit 312 to make input on a GUI screen (see FIG. 11C to be described later) for setting the mode.

The user operates the input/output unit 312 to set the control processing mode. In S1001, the CPU 301 receives user input and determines which one of an automatic restore mode, a warning display mode, and a function OFF mode is indicated by the received content. The processing proceeds to S1002 if the content of the received user input is the automatic restore mode, proceeds to S1003 if the content is the warning display mode, and proceeds to S1004 if the content is the function OFF mode.

In S1002, the CPU 301 sets the control processing mode of the printing apparatus to the automatic restore mode. Specifically, the setting value of the control processing mode stored in the memory 303 is updated to a value indicating the automatic restore mode.

In S1003, the CPU 301 sets the control processing mode of the printing apparatus to the warning display mode. Specifically, the setting value of the control processing mode stored in the memory 303 is updated to a value indicating the warning display mode.

In S1004, the CPU 301 sets the control processing mode of the printing apparatus to the function OFF mode. Specifically, the setting value of the control processing mode stored in the memory 303 is updated to a value indicating the function OFF mode.

The processing described above sets the control processing mode specifically, and determines the control processing to be executed as the ejection state changes in the future.

### <GUI Screen Displayed on Input/Output Unit 312>

Although the processing of setting the control processing mode has been described thus far with reference to FIG. 10, the user can confirm or change the contents of the control processing mode already set through the GUI screen displayed on the input/output unit 312. This will be described with reference to FIGS. 11A to 11C. FIGS. 11A to 11C each show a GUI screen displayed on the input/output unit 312.

FIG. 11A is a diagram showing a GUI screen displayed on the input/output unit 312 as the printing apparatus is in a standby state, that is, before a print job is sent from the host apparatus 1 to the printing apparatus. In the standby state, the user can configure the settings, such as a printing mode of the printing apparatus, printing paper, and whether or not adjustment functions can be executed by the printing apparatus, and can also execute a maintenance function to maintain good printing conditions.

FIG. 11B is a diagram showing a GUI screen displayed upon selection of automatic maintenance settings from the menu of the GUI screen shown in FIG. 11A. This GUI screen is created based on information one level below FIG. 11A. The screen of FIG. 11B shows items that the user can select, as various items related to the automatic maintenance settings. Items of various functions related to the maintenance and performance maintenance of the printing apparatus are aggregated in this screen. For example, the user can select settings related to a function (automatic nozzle check) to automatically check the ejection state of the nozzles of the printing head 201 using the droplet detection sensor 205 via the screen of FIG. 11B. The user can also select settings related to a function (cleaning interval) to periodically perform cleaning to remove foreign substances remaining in the nozzles via the screen of FIG. 11B. Furthermore, the mode setting of the ejection state determination sequence according to the present embodiment is managed by “checking ink ejection state” among the items shown in FIG. 11B.

FIG. 11C shows a GUI screen displayed upon selection of “checking ink ejection state” among the items shown in FIG. 11B. The screen of FIG. 11C shows items that the user can select. Specifically, in a case where the ejection state determination sequence according to the present embodiment is executed and it is determined that there is a change in the ejection state, a list of mode settings is displayed that can be selected for various types of control executed by the printing apparatus. The user arbitrarily selects one display item via the screen “checking ink ejection state” shown in FIG. 11C. This makes it possible to set the mode of the ejection state determination sequence to any one of the automatic restore mode, warning display mode, and function OFF mode.

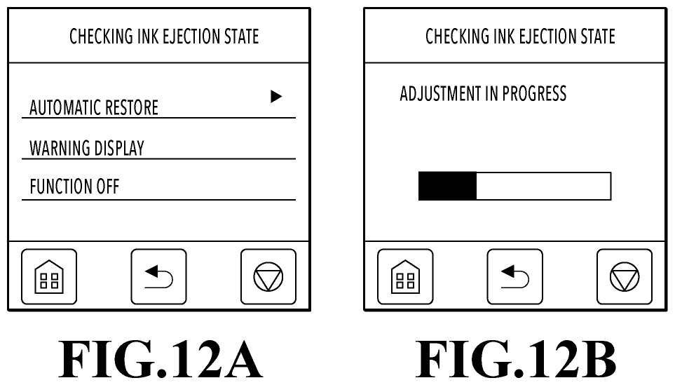

FIG. 12A shows a GUI screen displayed on the input/output unit 312 upon selection of the automatic restore mode for the mode setting of the ejection state determination sequence via the screen of FIG. 11C. In FIG. 12A, a triangle mark is displayed to the right of “automatic restore”. This mark indicates that the automatic restore mode is set via the screen of FIG. 11C.

In this mode setting, registration adjustment processing is executed based on the detection result upon determination by the ejection state determination sequence of the printing apparatus that there is a change in the ejection state. In this registration adjustment, a registration adjustment value stored in the printing apparatus is restored (updated). Specifically, the registration adjustment value can be automatically restored using a look-up table prepared in advance to make the adjustment value variable, based on the detection result upon determination that there is a change in the ejection state.

FIG. 12B shows a GUI screen displayed upon execution of the automatic restore function via the screen of FIG. 12A. Upon determination that there is a change in the ejection state, a message indicating that adjustment is in progress is displayed on the input/output unit 312 during restoration of the registration adjustment value, and the progress is displayed by a progress bar. This makes it possible for the user to know the progress.

The user can also directly perform registration adjustment by printing an adjustment pattern on his/her printing paper loaded to the printing apparatus, instead of executing the automatic restore function. In that case, the printed adjustment pattern may be read by the paper detection sensor 204 to automatically execute control to calculate a newly applied adjustment value. If there is no change in the ejection volume but there is a change in the ejection speed, the landing position on the printing paper changes. Therefore, the CPU 301 can respond to the change in the ejection state by changing the ejection timing. Therefore, the registration is adjusted to determine the ejection timing for ejecting at the landing position. The CPU 301 may also execute density adjustment in the printing processing of the printing apparatus 100. The CPU 301 may further execute processing to change the distance between the printing head 201 and the printing paper in the printing processing of the printing apparatus 100. Thus, different processing may be executed depending on the changed ejection state.

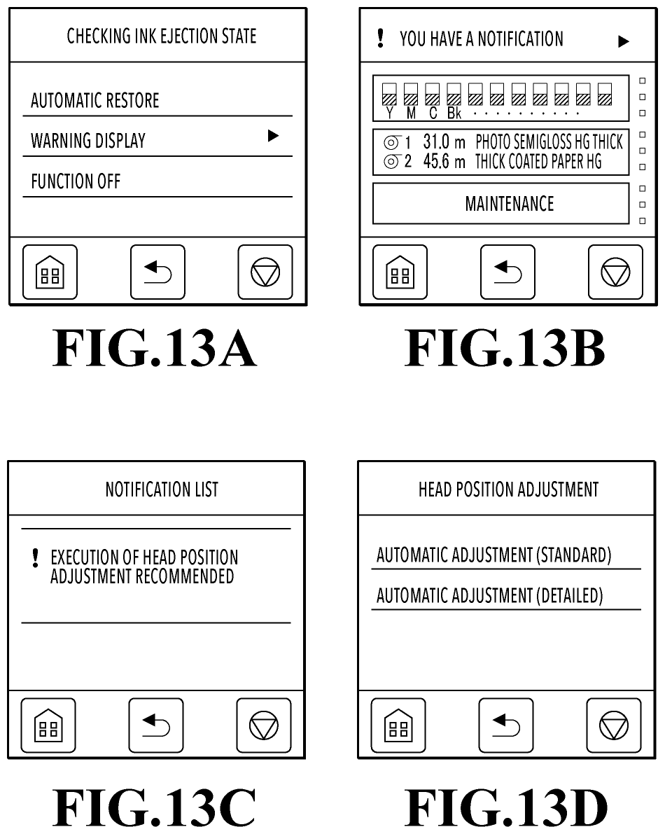

FIG. 13A shows a GUI screen displayed on the input/output unit 312 upon selection of the warning display mode for the mode setting of the ejection state determination sequence via the screen of FIG. 11C. In FIG. 13A, a triangle mark is displayed to the right of “warning display”. This mark indicates that the warning display mode is set via the screen of FIG. 11C.

In this warning display mode, upon determination by the ejection state determination sequence of the printing apparatus that there is a change in the ejection state, a warning is displayed via the input/output unit 312 based on the detection result. For example, FIG. 13B shows a GUI screen displayed on the input/output unit 312 in this event. When the printing apparatus is in the standby state shown in FIG. 11A, a warning message is displayed in the upper part of the GUI screen so that the user can recognize the warning, as shown in FIG. 13B.

FIG. 13C is a GUI screen displaying details of the warning notified in FIG. 13B. By the user selecting the warning message portion of the screen in FIG. 13B, the displayed GUI screen shifts from the screen of FIG. 13B to the screen of FIG. 13C. As shown in FIG. 13C, this screen includes a list of warning displays (notification list) notified to the user. In this example, since it is determined by the ejection state determination sequence that there is a change in the ejection state, a warning to that effect is displayed. In other words, FIG. 13C is a screen for recommending that the user perform registration adjustment processing by arbitrary operation, since there is a possibility that the registration adjustment value stored in the printing apparatus is not an optimal value.

FIG. 13D is a GUI screen for the user to select the recommended registration adjustment processing. By the user selecting the warning message portion of the screen in FIG. 13C, the displayed GUI screen shifts from the screen of FIG. 13C to the screen of FIG. 13D. The user can easily instruct the execution (or re-execution) of the recommended registration adjustment function via the screen of FIG. 13D, without having to look up how to deal with the problem corresponding to the warning display.

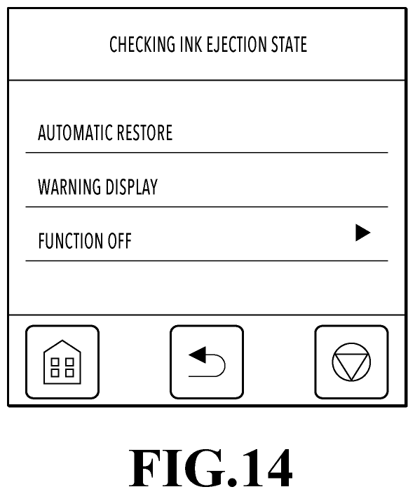

FIG. 14 shows a GUI screen displayed on the input/output unit 312 upon selection of the function OFF mode for the mode setting of the ejection state determination sequence via the screen of FIG. 11C. The function OFF mode setting is a setting for a case where there is no need for the automatic restore function or the warning display function, such as a situation where the registration adjustment processing is constantly performed by the user operation. In a case where the printing apparatus 100 is set to the function OFF mode by the user, the ejection state determination sequence is not executed in the printing apparatus, and the determination of a change in the ejection state is not performed.

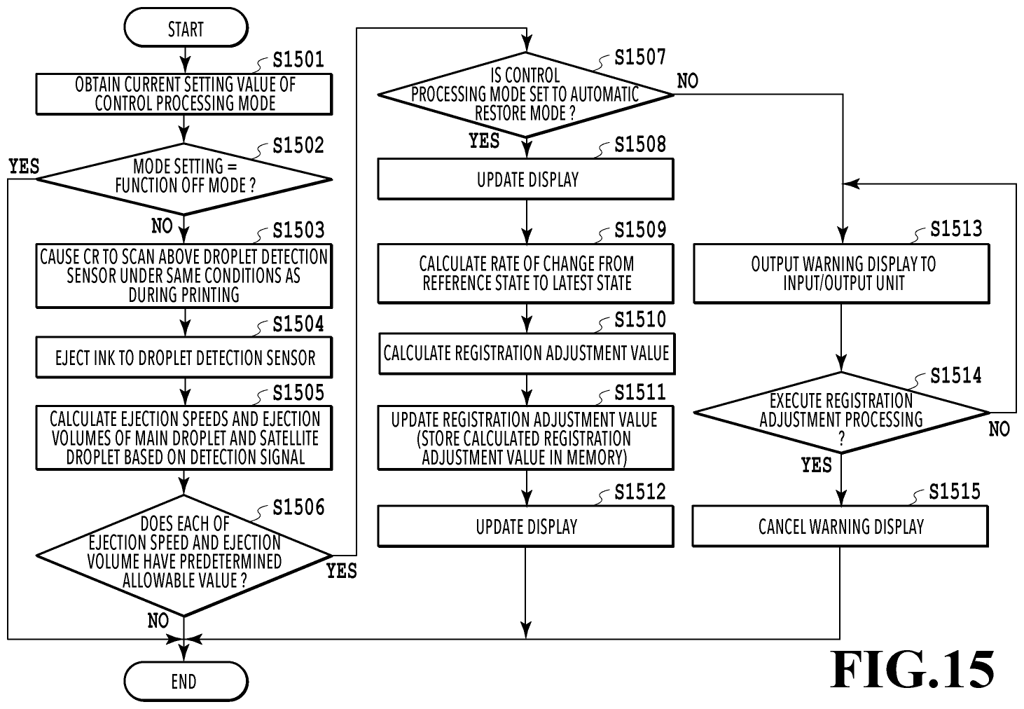

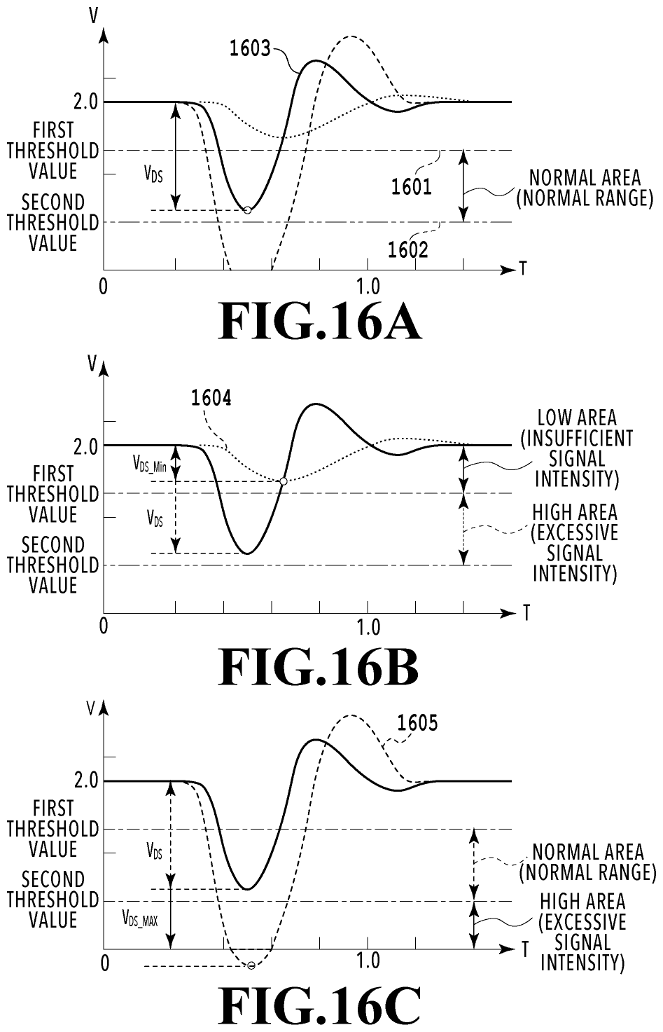

FIG. 15 shows a flow chart of the ejection state determination sequence executed by the printing apparatus 100 according to the present embodiment. As in FIG. 6, a series of processing shown in FIG. 15 is executed by the CPU 301 according to a program stored in the memory 303 as a predetermined time elapses or as the dot count corresponding to the total number of ejections from all nozzles exceeds a predetermined threshold. Alternatively, it is also conceivable to execute the processing immediately after a nozzle cleaning operation, in order to determine the change of state with high accuracy in a stable state of the nozzles.

In S1501, the CPU 301 obtains the current setting value of the control processing mode (see FIG. 10). This mode setting value is stored in the memory.

In S1502, the CPU 301 uses the mode setting value obtained in S1501 to determine whether the mode setting of the ejection state determination sequence set for the printing apparatus is the function OFF mode. In other words, it is determined whether the mode setting value obtained in S1501 is a value indicating the function OFF mode. The series of processing ends if the determination result in this step is true, or proceeds to S1503 if the determination result is false.

The processing of S1503 to S1506 is the same as that of S601 to S604 according to the first embodiment. In S1506, the initial or past ejection state (reference state) is compared with the current ejection state to determine whether or not there is a change in the ejection state. If the determination result in S1506 is false, the ejection state is determined to be not changed, and the series of processing ends.

In S1507, the CPU 301 determines whether the setting value of the control processing mode obtained in S1501 indicates the automatic restore mode. If the determination result in this step is true, the processing proceeds to S1508. On the other hand, if the determination result in this step is false, the processing proceeds to S1513.

In S1508, the CPU 301 updates the display in the input/output unit 312. Specifically, the GUI screen of FIG. 12B is displayed to update the progress bar display according to the progress of the subsequent processing.

In S1509, the CPU 301 calculates a rate of change from a reference state to the current state (latest state), based on parameters of the reference state and parameters of the current state (latest state). Specifically, the rate of change calculated in this step is a rate of change in the ejection speed and a rate of change in the ejection volume.

In S1510, the CPU 301 calculates a registration adjustment value based on the rate of change calculated in S1509.

In S1511, the CPU 301 updates the registration adjustment value. That is, the CPU 301 stores (overwrites) in the memory the registration adjustment value calculated in S1510.

In S1512, the CPU 301 updates the display in the input/output unit 312 and notifies the user of the completion of automatic restore. The series of processing then ends after this step.

In S1513, the CPU 301 updates the display in the input/output unit 312 and outputs a warning display. Specifically, the GUI screen of FIG. 13C is displayed. This GUI screen has a message recommending that the user adjust the registration. Upon checking the message, the user operates the input/output unit 312 to execute the registration adjustment processing.

In S1514, the CPU 301 determines whether to execute the registration adjustment processing based on user input. If the determination result in this step is true, the registration adjustment processing is executed and then the processing proceeds to S1515. On the other hand, if the determination result in this step is false, the processing returns to S1513 to continue outputting the warning display.

In S1515, the CPU 301 updates the display in the input/output unit 312 and cancels the warning display. The series of processing then ends after this step.

In the flow described above, if the registration adjustment processing is not executed in S1514 based on the user input, the warning display is not updated. However, if the user determines that the warning display is an obstacle to operation, the operation of the printing apparatus may be continued with the warning display remaining on by a predetermined operation. Alternatively, the user may be able to continue the operation after canceling the warning display itself by a predetermined operation at his/her own discretion.

### Third Embodiment (Adjusting Test Ejection Parameters to Amplify or Attenuate Detection Signal Corresponding to Reference Ejection State)

In the first embodiment, the description is given of the case where the ejection state is checked for a change, and if the amount of change in the current (latest) ejection state from the reference ejection state is greater than or equal to a certain amount, it is determined that there is a change in the ejection state. In the second embodiment, the description is given of the case where if it is determined by the ejection state determination sequence according to the first embodiment that there is a change in the ejection state, the printing apparatus executes processing according to the control processing mode setting selected by the user.

Upon measuring the reference ejection state used in the ejection state determination sequence, the ejection state can be determined to be not normal, that is, the detection signal obtained by the droplet detection sensor can be an abnormal output. Using such a reference makes it difficult to compare the reference ejection state with the latest ejection state, and the change in the ejection state cannot be accurately detected.

Two possible main reasons why the detection signal corresponding to the reference ejection state becomes an abnormal output are as follows. The first reason is that the ejection operation tends to change easily in a state where a heater of the nozzle unit and the ink come into contact for the first time in the printing head immediately after being attached to the printing apparatus. The second reason is that a slight deviation in each nozzle used for the test causes a deviation in the fly direction of the ejected droplets, causing a change in the proportion of the light beam 404 properly blocked in the droplet detection sensor 205.

In the present embodiment, upon determination of the reference ejection state in the ejection state determination sequence, if the detection signal is determined to be abnormal, the parameters used for test ejection are adjusted to obtain a more appropriate detection signal. In this respect, the present embodiment differs from the first embodiment. Note that the basic configuration is the same as that of the first embodiment, and thus description of the contents common to the first embodiment will be omitted as appropriate.

FIGS. 16A to 16C each show a detection signal to be obtained in the present embodiment and used as a reference, which is similar to the detection signals obtained in the ejection state determination sequence described in the first embodiment. FIGS. 16A to 16C each shows a normal detection signal or an abnormal detection signal.

FIG. 16A shows a case where the obtained detection signal is normal, and a waveform indicated by a solid line represents the obtained detection signal. In the present embodiment, if a peak value falls between a first threshold value 1601 and a second threshold value 1602 (specifically, the second threshold value≤peak value≤the first threshold value), the detection signal is determined to be normal. In the case of FIG. 16A, the second threshold value≤peak value (VDS)≤the first threshold value is satisfied, and thus the detection signal is determined to be normal. As a result, the presence or absence of a change in the ejection state is determined based on a comparison between the initial state indicated by the detection signal and the current (latest) state indicated by the current (latest) detection signal.

FIG. 16B shows a case where the obtained detection signal is abnormal, and a waveform indicated by a dotted line represents the obtained abnormal detection signal 1604. As described above, if the second threshold value≤peak value≤the first threshold value, the detection signal is determined to be normal. However, in the case of FIG. 16B, the peak value VDS_Min does not satisfy the second threshold value≤peak value≤the first threshold value. Therefore, the detection signal is determined to be abnormal. In this case, the parameters set for the test ejection of the ejection state determination sequence are corrected, and then the detection signal corresponding to the reference ejection state is obtained again, or a determination is made as to whether or not the obtained detection signal is normal.

FIG. 16C shows a case where the obtained detection signal is abnormal, and a waveform indicated by a dashed line represents the obtained abnormal detection signal 1605. As described above, if the second threshold value≤peak value≤the first threshold value, the detection signal is determined to be normal. However, in the case of FIG. 16C, the peak value VDS_MAX does not satisfy the second threshold value≤ peak value≤the first threshold value. Therefore, the detection signal is determined to be abnormal. In this case, the parameters set for the test ejection of the ejection state determination sequence are corrected, and then the detection signal corresponding to the reference ejection state is obtained again, or a determination is made as to whether or not the obtained detection signal is normal.

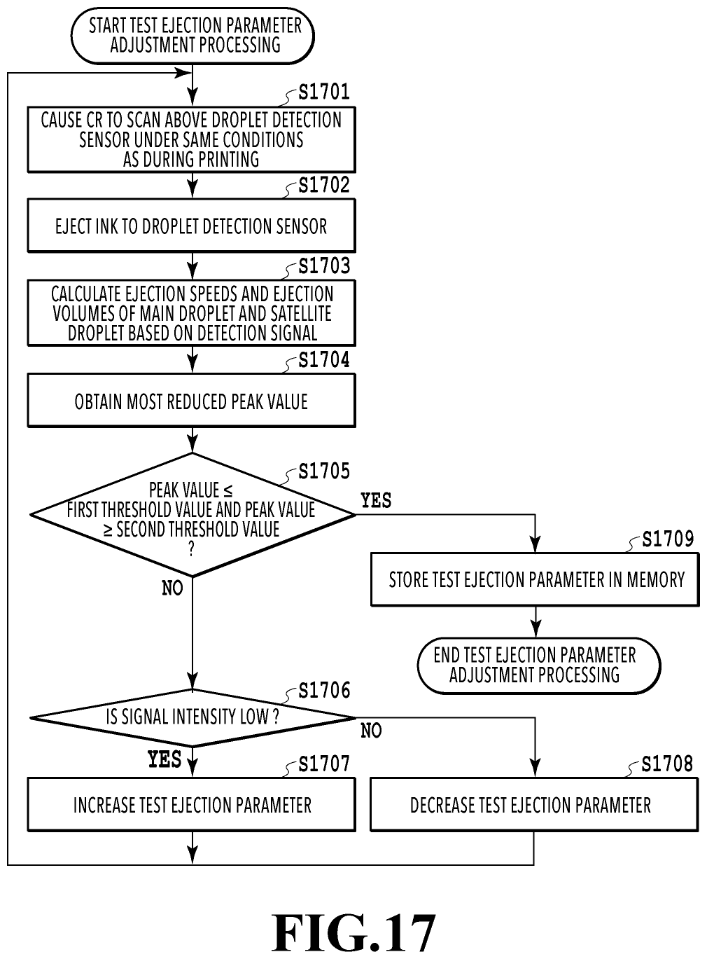

FIG. 17 is a flowchart of processing executed by the printing apparatus 100 according to the present embodiment, in which a determination is made as to whether the detection signal used as the reference in the ejection state determination sequence is normal or abnormal, and the test ejection parameters are adjusted if the detection signal is determined to be abnormal. This processing is referred to as test ejection parameter adjustment processing. The test ejection parameter adjustment processing is executed by the CPU 301 according to a program stored in the memory 303. The test ejection parameter adjustment processing is also executed at a predetermined appropriate timing, such as at the time of initial installation (as the printing apparatus is turned on for the first time), as the printing head is replaced with a new one, or immediately after the registration adjustment processing is executed based on user input.

The processing of S1701 to S1703 is the same as that of S601 to S603 according to the first embodiment. After S1703, ink is ejected from the test ejection nozzle to obtain a detection signal corresponding to a reference ejection state.

In S1704, the CPU 301 obtains a peak value (local minimum value) in the detection signal.

In S1705, the CPU 301 determines whether the second threshold value≤peak value≤the first threshold value is satisfied for the peak value obtained in S1704. If the determination result in this step is true, the processing proceeds to S1709. On the other hand, if the determination result in this step is false, the processing proceeds to S1706.

In S1706, the CPU 301 determines whether the signal intensity of the detection signal is Low (that is, in a state as shown in FIG. 16B). Specifically, it determines whether the peak value obtained in S1704 satisfies the peak value>the first threshold value. If the determination result in this step is true, the signal intensity is determined to be insufficient, and the processing proceeds to S1707. On the other hand, if the determination result in this step is false, the peak value<the second threshold value is naturally satisfied, which means that the detection signal is in a state as shown in FIG. 16C. Therefore, the signal intensity is determined to be excessive, and the processing proceeds to S1708.

In S1707, the CPU 301 adjusts (specifically increases) the test ejection parameters in order to amplify the insufficient detection signal. The test ejection parameters include the number of nozzles used for test ejection, the number of ejections from the nozzles during test ejection, and the like, and these parameters are increased in this step.

In S1708, the CPU 301 adjusts (specifically reduces) the test ejection parameters to attenuate the excessive detection signal. As described above, the test ejection parameters include the number of nozzles used for test ejection, the number of ejections from the nozzles during test ejection, and the like. These parameters are reduced in this step.

After S1707 or S1708, the processing returns to S1701, and the processing of S1701 to S1705 is executed again. Finally, if the determination result in S1705 is true, the processing proceeds to S1709.

In S1709, the CPU 301 updates the test ejection parameters, that is, stores (overwrites) in the memory the test ejection parameters derived in the most recent S1707 or S1708, and ends the series of processing. This step is not executed if the processing does not go through S1707 or S1708, and the series of processing ends if the determination result in S1705 is YES.

As a result of the test ejection parameter adjustment processing shown in FIG. 17, the test ejection parameters can be updated. In the subsequent ejection state determination sequence, the test is performed using the updated test ejection parameters.

As described above, in the present embodiment, in a case where a detection signal corresponding to the reference ejection state is obtained as an abnormal output, the test ejection parameters are adjusted so that the detection signal becomes a normal output. This makes it possible to subsequently perform the ejection state determination sequence with high accuracy.

### Fourth Embodiment

In the present embodiment, it is determined whether the printing paper is in a paper feeding state (a state where the printing paper is set in a printing ready state) and processing is executed based on the determination result.

FIG. 2 described above shows a state where the printing paper 203 is set on the platen 212. In this state, it is possible to determine whether or not the printing paper 203 is set on the platen 212 and therefore is in the paper feeding state, by detecting the printing paper 203 with the paper detection sensor 204.

FIGS. 5A to 5D show how the ink droplet ejection speed is calculated based on the time difference between the detection times of ink droplets as the lift motor 211 is driven to change the distance between the printing head 201 and the droplet detection sensor 205. With this configuration, the distance between the printing head 201 and the droplet detection sensor 205 can be changed by driving the lift motor 211, and a plurality of separation distances and the detection times corresponding to each of these distances can be measured. This makes it possible to accurately calculate the ink droplet ejection speed.

However, in a case where the lift motor 211 is driven to change the position of the printing head 201, with the printing paper 203 set on the platen 212, the printing head 201 may come into contact with the printing paper 203, resulting in contamination of the printing paper 203.

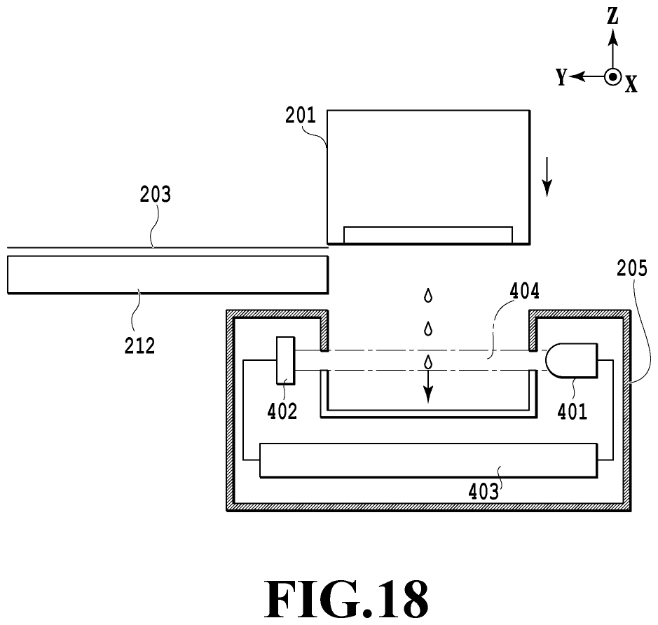

FIG. 18 shows a state where the printing head 201 comes into contact with the printing paper 203 as the printing head 201 is lowered with the printing paper 203 set on the platen 212. In such a paper feeding state with the printing paper 203 set, there is a restriction that the detection time of the ink droplets cannot be detected by changing the position of the printing head 201.

On the other hand, in the case of droplet detection performed while driving the CR as described with reference to FIGS. 6 and 7, the CR 202 is driven under the same conditions as during the printing operation, in order to monitor a change in the landing state of the droplet ejected onto the printing paper. Therefore, since the measurement is performed without changing the distance (carriage height) between the CR 202 and the printing paper, the printing head 201 does not come into contact with the printing paper 203 even if the printing paper 203 is set on the platen 212. Therefore, in the paper feeding state, the droplet detection needs to be performed while driving the CR.

In the present embodiment, therefore, a configuration is adopted in which the paper detection sensor 204 determines whether or not the paper is fed, and the droplet detection is performed while driving the CR 202 if the paper is fed, or the droplet detection is performed without driving the CR 202 if no paper is fed. This configuration makes it possible to perform appropriate droplet detection according to the state.

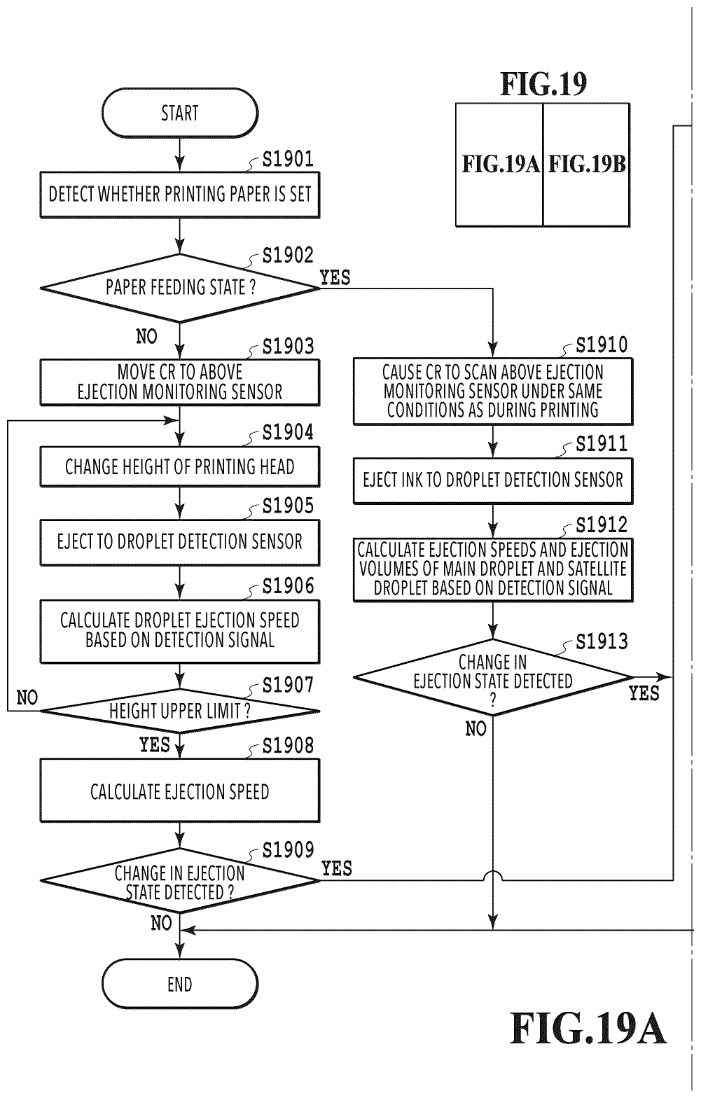

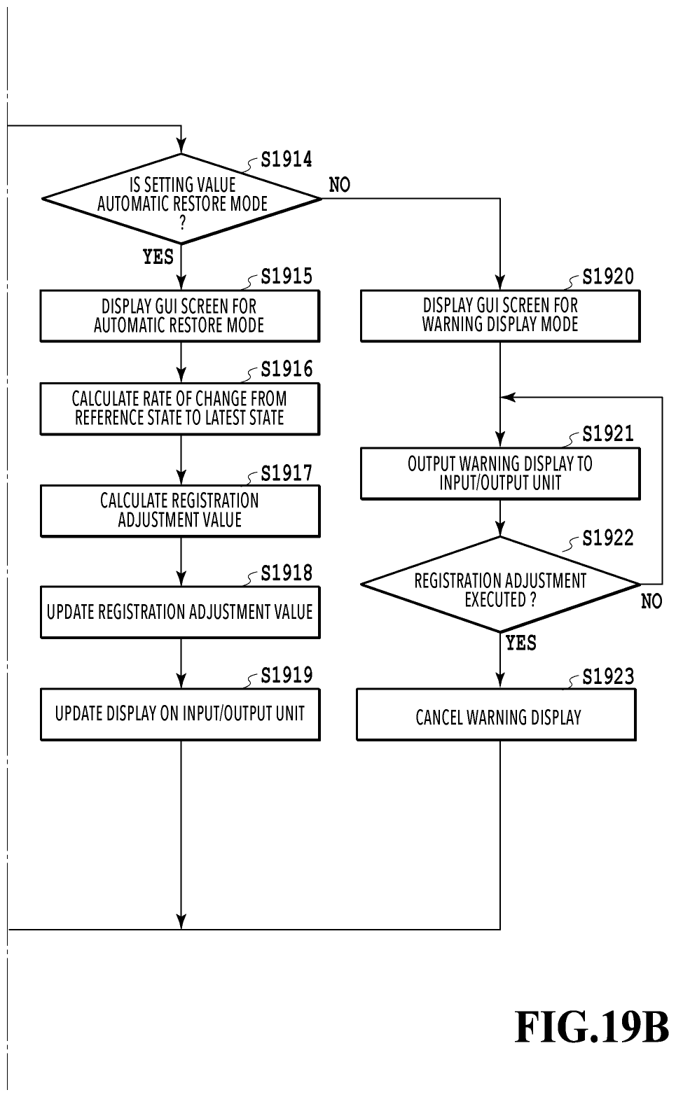

FIG. 19A and FIG. 19B collectively show a flowchart of processing executed by the printing apparatus 100 according to the present embodiment to determine the paper feeding state and switch the type of ejection state determination sequence. As with FIG. 6, a series of processing shown in FIG. 19A and FIG. 19B is executed by the CPU 301 according to a program stored in the memory 303 as a predetermined time elapses or as the dot count corresponding to the total number of ejections from all nozzles exceeds a predetermined threshold. Alternatively, it is also conceivable to execute the processing immediately after a nozzle cleaning operation, in order to determine the change of state with high accuracy in a stable state of the nozzles. The processing according to the present embodiment will be described below while applying specific examples (FIGS. 5A to 5D) to the flow of FIG. 19A and FIG. 19B.

In S1901, the CPU 301 uses the paper detection sensor 204 to detect whether or not the printing paper 203 is set.

In S1902, the CPU 301 determines whether the printing apparatus 100 is in the paper feeding state based on the detection result obtained in S1901. The processing proceeds to S1910 if the determination result in this step is true, or proceeds to S1903 if the determination result is false.

In the processing of S1903 to S1909, droplet detection is performed without driving the CR 202. Specifically, as described in FIGS. 5A to 5D, the lift motor 211 is driven to increase the distance between the printing head 201 and the droplet detection sensor 205, thus changing the height of the printing head 201 in multiple steps. The ejection speed of ink droplets ejected from the printing head 201 corresponding to each step is detected.

In S1903, the CPU 301 moves the CR 202 to above the droplet detection sensor 205.

In S1904, the CPU 301 drives the lift motor 211 to change the height of the printing head 201. In this example, the height of the printing head 201 is specifically moved to the first distance H1.

In S1905, the head control unit 310 and the head control circuit 305 in the CPU 301 cause ink droplets to be ejected from the printing head 201 toward the droplet detection sensor 205 based on an ejection signal.

In S1906, the CPU 301 calculates the ejection speed of the ink droplet based on a detection signal from the light receiving element 402. In this step, the timing at which the amount of light changes as the ink droplet ejected from the printing head 201 passes through the light beam 404 is used. Specifically, in this example, the detection time (first detection time T1) between the generation of the ejection signal and the output of the detection signal is obtained as the detection time corresponding to the first distance H1 between the printing head 201 and the droplet detection sensor 205.

In S1907, the CPU 301 determines whether the current height of the printing head 201 has reached the set upper limit. If the determination result in this step is true, the processing proceeds to S1908. On the other hand, if the determination result in this step is false, the processing returns to S1904. In this example, the processing returns to S1904.

In S1904, the CPU 301 drives the lift motor 211 to move the printing head 201 to the second distance H2.

In S1905, the head control unit 310 and the head control circuit 305 in the CPU 301 cause ink droplets to be ejected from the printing head 201 toward the droplet detection sensor 205 based on an ejection signal.

In S1906, the CPU 301 calculates the ejection speed of the ink droplet based on a detection signal from the light receiving element 402. In this step, the timing at which the amount of light changes as the ink droplet ejected from the printing head 201 passes through the light beam 404 is used. Specifically, in this example, the detection time (second detection time T2) between the generation of the ejection signal and the output of the detection signal is obtained as the detection time corresponding to the second distance H2 between the printing head 201 and the droplet detection sensor 205.

Again in S1907, the CPU 301 determines whether the height of the printing head 201 has reached the set upper limit. If the determination result in this step is true, the processing proceeds to S1908. On the other hand, if the determination result in this step is false, the processing returns to S1904. As the height of the printing head 201 reaches the set upper limit (H4 in this example), the processing exits the repetition of S1904 to S1907 and proceeds to S1908.

In S1908, the CPU 301 uses the detection times (times T1 to T4) for each of the obtained heights (distances H1 to H4) of the printing head 201 to calculate an ejection speed V of the ink droplet for each height difference, based on the respective distance differences and respective time differences. Specifically, a first ejection speed V1 of the ink droplet is calculated based on a distance difference between the distance H1 and the distance H2 and a time difference between the detection time T1 and the detection time T2. A second ejection speed V2 of the ink droplet is calculated based on a distance difference between the second distance H2 and the third distance H3 and a time difference between the second detection time T2 and the third detection time T3. A third ejection speed V3 of the ink droplet is calculated based on a distance difference between the third distance H3 and the fourth distance H4 and a time difference between the third detection time T3 and the fourth detection time T4.

In S1909, the CPU 301 compares each of the plurality of ejection speeds calculated in S1908 with a threshold value (preset) used to determine whether the image quality may be deteriorated, and determines whether the amount of change in each of the ejection speeds is greater than the threshold value. If the determination result in this step is true, it is determined that there is a change in the ejection state, and the processing proceeds to S1914. On the other hand, if the determination result in this step is false, it is determined that there is no change in the ejection state, and the series of processing ends.

The processing of S1910 to S1912 is the same as the processing (S601 to S603) in the detection processing (see FIG. 6) according to the first embodiment.

In S1910, the CPU 301 causes the CR 202 to scan under the same conditions as during printing and pass over the droplet detection sensor 205.

In S1911, the CPU 301 causes ink droplets to be ejected toward the droplet detection sensor 205 so that the ink droplets pass through the light beam 404.

In S1912, the CPU 301 calculates the ejection speed and ejection volume of the main droplet and the ejection speed and ejection volume of the satellite droplet, based on the detection signal from the light receiving element 402. The calculation method is the same as that in the first embodiment (see FIG. 6), and thus description thereof will be omitted here.

In S1913, the initial or past ejection state (reference state) is compared with the current ejection state to determine whether a change in the ejection state is detected. If the determination result in this step is true, the processing proceeds to S1914. On the other hand, if the determination result in this step is false, the series of processing ends.

In S1914, the CPU 301 obtains the current setting value (see FIG. 10) of the control processing mode stored in the memory, and determines whether the obtained setting value indicates the automatic restore mode. If the determination result in this step is true, the processing proceeds to S1915. On the other hand, if the determination result in this step is false, the processing proceeds to S1920.

In S1915, the CPU 301 updates the display in the input/output unit 312. Specifically, the CPU 301 displays the GUI screen of FIG. 12B to update the display of the progress bar according to the progress of the subsequent processing.

In S1916, the CPU 301 calculates a rate of change in the current state (latest state) from the reference state, based on the parameters of the reference state and the parameters of the current state (latest state). The rate of change calculated in this step is specifically a rate of change in the ejection speed and a rate of change in the ejection volume.

In S1917, the CPU 301 calculates a registration adjustment value based on the rate of change calculated in S1916.

In S1918, the CPU 301 updates the registration adjustment value. That is, the CPU 301 stores (overwrites) in the memory the registration adjustment value calculated in S1917.

In S1919, the CPU 301 updates the display in the input/output unit 312 and notifies the user of the completion of the automatic restore. The series of processing then ends after this step.

In S1920, the CPU 301 updates the display in the input/output unit 312 and outputs a warning display. Specifically, the CPU 301 displays the GUI screen of FIG. 13B to notify the user of a warning display. The processing proceeds to S1921 as the user looks at this screen and selects the warning message portion.

In S1921, the CPU 301 updates the display in the input/output unit 312 and outputs a warning display. Specifically, the CPU 301 displays the GUI screen of FIG. 13C. This GUI screen has a message recommending that the user adjust the registration. Upon checking the message, the user operates the input/output unit 312 to execute the registration adjustment processing.

In S1922, the CPU 301 determines whether to execute the registration adjustment processing based on the user input in S1921. If the determination result in this step is true, the registration adjustment processing is executed and then the processing proceeds to S1923. On the other hand, if the determination result in this step is false, the processing returns to S1921 to continue outputting the warning display.

In S1923, the CPU 301 updates the display in the input/output unit 312 and cancels the warning display. The series of processing then ends after this step.

In the flow described above, if the registration adjustment processing is not executed in S1922 based on the user input, the warning display is not updated. However, if the user determines that the warning display is an obstacle to operation, the operation of the printing apparatus may be continued with the warning display remaining on by a predetermined operation. Alternatively, the user may be able to continue the operation after canceling the warning display itself by a predetermined operation at his/her own discretion.

As described above, according to the present embodiment, it is determined whether the printing paper is in the paper feeding state, and if so, the droplet detection processing is performed while driving the CR. On the other hand, if the printing paper is not in the paper feeding state, the droplet detection processing is performed while changing the CR height. With this configuration, the nozzle ejection state of the printing apparatus can be detected accurately and appropriately according to the user's usage pattern, such as performing printing continuously with the printing paper loaded or performing printing after the printing paper is left for a long period of time without being loaded. Therefore, it is possible to prevent printing failure due to aging (deterioration) or unintended changes in ejection.

### Fifth Embodiment

In the present embodiment, it is determined whether the printing paper is in the paper feeding state, and if so, the droplet detection processing is performed while driving the CR. Also, if it is determined that there is a change in the ejection state, upon detecting that the paper feeding state is released (the printing paper is removed), the droplet detection processing is performed while changing the CR height. Through this processing, the ink droplet ejection speed is calculated, and the ejection timing is adjusted based on the calculated ejection speed to suppress deterioration in image quality due to deviation in landing position.

In FIG. 6 described above, the description is given of the processing of detecting the nozzle ejection state by scanning of the CR 202 under the same conditions as during printing operation.

If the CPU 301 determines in S604 that there is a change in the ejection state, the processing proceeds to S605. In S605, the CPU 301 sets a flag value of a detection NG flag stored in the memory 303 to ON. The “detection NG flag” is a flag indicating that the ejection state of the printing head 201 is not detected to be normal (in a normal state). Therefore, by adjusting the ejection timing in a case where the detection NG flag is ON, the deterioration in image quality due to deviation in landing position can be suppressed. In a case where the detection NG flag is OFF, on the other hand, it can be determined that there is no need to adjust the ejection timing since there is no deterioration in image quality due to deviation in landing position.

As described in the fourth embodiment, a plurality of separation distances and the detection times corresponding to each of the distances can be measured by driving the lift motor 211 to change the distance between the printing head 201 and the droplet detection sensor 205, as described with reference to FIGS. 5A to 5D. This configuration makes it possible to accurately calculate the ejection speed of the ink droplet.

However, as described with reference to FIG. 18, lowering the position of the printing head 201 in the paper feeding state may cause the printing head 201 to come into contact with the printing paper 203. For this reason, the processing of detecting droplets while changing the CR height needs to be performed in a state other than the paper feeding state.

Therefore, upon determining by the paper detection sensor 204 that the paper is not being fed, the droplet detection processing needs to be executed while changing the CR height, but it is sufficient to refer to the detection NG flag stored in the memory 303 in this event. In other words, the droplet detection processing is executed while changing the CR height if the detection NG flag is ON. On the other hand, the droplet detection processing is not executed if the detection NG flag is OFF. This configuration makes it possible to avoid executing unnecessary processing in a case where there is no need to execute the droplet detection processing.

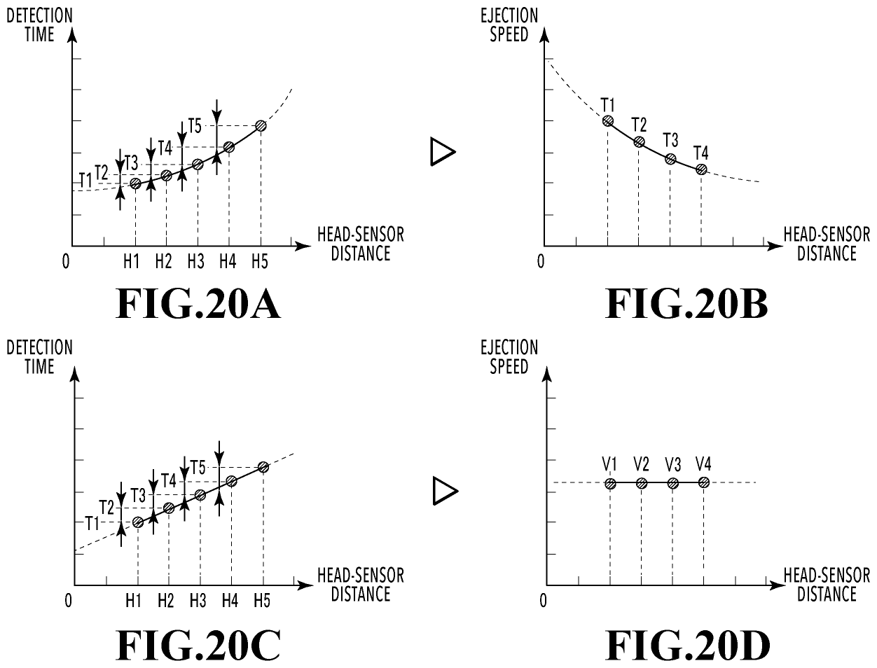

With reference to FIGS. 20A to 20D, description will be given below of a case where the present embodiment is applied to a method for calculating the ejection speed in the case of executing the droplet detection processing while changing the CR height, as described in FIGS. 5A to 5D.

FIGS. 20A and 20C are graphs showing the relationship between the distance between the ejection port surface 201a and the light beam 404 of the droplet detection sensor 205 (referred to as the head-sensor distance in FIGS. 20A and 20C) and the detection time output result at each distance, as described with reference to FIGS. 5A to 5D. FIG. 20B is a graph showing the relationship between the head-sensor distance and the ejection speed calculated based on the distance and detection time shown in FIG. 20A. FIG. 20D is a graph showing the relationship between the head-sensor distance and the ejection speed calculated based on the distance and detection time shown in FIG. 20C.

In the graph shown in FIG. 20A, the vertical axis represents the detection time detected by the sequence control unit 307, and the horizontal axis represents the distance between the ejection port surface 201a of the printing head 201 and the light beam 404 of the droplet detection sensor 205. The points actually measured are indicated by the hatched circles in FIG. 20A. Here, detection is performed at distances H1 to H5. The distance H5 is further away than the distance H4.

In the graph shown in FIG. 20B, the vertical axis represents the ejection speed, and the horizontal axis represents the difference between the separation distances. In this event, as for the calculated ejection speed data, non-linearly changing data may be obtained due to various influences. Therefore, in order to more accurately calculate the ejection speed data indicating each distance difference, an approximation curve of a polynomial of second degree or higher is obtained from the obtained ejection speed data, and the polynomial of the approximation curve thus obtained is used as the formula that represents the ejection speed. To obtain the approximation curve, three or more ejection speeds are used. To calculate three or more ejection speeds, it is necessary to detect the detection times at four or more distances. The method of calculating the ejection speed is as described above.

The inventors have empirically found that linearly changing data may be obtained depending on individual differences of the printing head, differences in physical properties between ink colors, and the usage conditions and environmental influences. FIG. 20C shows such linearly changing data. In this case, again, the ejection speed can be calculated based on the detection time at each distance and the difference in distance between the ejection port surface 201a and the light beam 404. FIG. 20D is a graph showing the relationship between the calculated ejection speed and the distance difference. As shown in FIG. 20D, the ejection speed calculated at each distance difference shows a constant value at any distance. If it is known that linearly changing data can be obtained, only one ejection speed needs to be obtained because the ejection speed is constant regardless of the distance. To calculate one ejection speed, it is sufficient to detect the detection times at two distances.

Even in a case where the ejection speed changes non-linearly, upon printing only if the distance between the ejection port surface 201a and the printing paper 203 is constant, it is not necessarily required to calculate an approximation curve. In that case, it is sufficient to detect the detection times at two distances including the distance during printing.

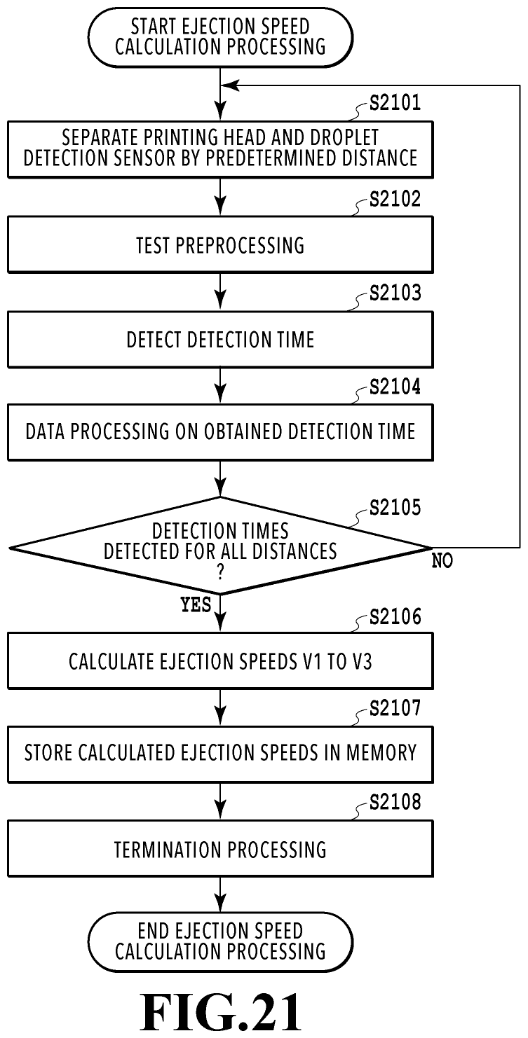

FIG. 21 is a flowchart of a specific example of processing to calculate the ejection speed, corresponding to FIGS. 5A to 5D and FIGS. 20A to 20D.

The ejection speed calculation processing shown in FIG. 21 is performed as the user of the printing apparatus 100 operates the printing apparatus 100 for the first time, or as the printing head 201 is replaced with a new one and attached. The ejection speed calculation processing may also be performed periodically for maintenance or according to the user's instructions. The processing of FIG. 21 is performed by the sequence control unit 307 of the CPU 301 in accordance with a program stored in the memory 303, for example.

In S2101, the sequence control unit 307 drives the lift motor 211 to separate the printing head 201 and the droplet detection sensor 205 by a predetermined distance. This separation distance is prestored in the memory 303, which is the distances H1 to H4 shown in FIGS. 5A to 5D in this example. The order of the separation distances is H1, H2, H3, and H4, as shown in FIGS. 5A to 5D.

In S2102, the sequence control unit 307 executes preprocessing required to detect the ejection speed. More specifically, the preprocessing includes presetting the optimal ejection control to detect the ejection speed, a preliminary ejection operation for stable ejection of ink droplets, stopping the suction fan to stabilize the airflow control inside the printing apparatus, and the like.

In S2103, the sequence control unit 307 detects the detection time by executing an ejection operation to eject test ink droplets from the printing head 201 to the light beam 404 emitted by the light emitting element 401 of the droplet detection sensor 205. To be more specific, at the separation distance in S2101, the detection time is detected as the time between the start of the ejection of ink droplets from a predetermined nozzle of the printing head 201 and the detection of the passage of the ink droplets through the light beam 404 by the light receiving element 402 of the droplet detection sensor 205. In this event, a plurality of detection times are detected as the detection time using a plurality of nozzles of the printing head 201. In order to accurately detect the ejection speed, it is desirable to select a wide range of nozzles including both ends and the center as the target nozzles for measuring the detection times.

In S2104, the sequence control unit 307 performs data processing on the detection time obtained in S2103 to calculate the detection time corresponding to the separation distance in S2101. To be more specific, the data processing executed here includes averaging processing based on the number of obtained samples required to stabilize the measurement of the detection time, deleting data outside the upper and lower error ranges to prevent the inclusion of abnormal values in the data, and the like.

In S2105, the sequence control unit 307 determines whether the detection time is detected for all distances (the distances H1, H2, H3, and H4 in this example) stored in the memory 303. If the determination result in this step is true, the processing proceeds to S2106. On the other hand, if the determination result in this step is false, the processing returns to S2101. Specifically, in this example, it is determined whether the distance (current distance) between the ejection port surface 201a and the light beam 404 of the droplet detection sensor 205 is the distance H4 as the final separation distance. If the current distance is not the distance H4, the processing returns to S2101, and the next set distance is applied to execute the same processing as described above. On the other hand, if the current distance is determined to be the distance H4, it is determined that the detection times are obtained at all distances, and the processing proceeds to S2106.

In S2106, the sequence control unit 307 executes calculation of the ejection speed. To be more specific, as described with reference to FIGS. 5A to 5D and FIGS. 20A to 20D, the ejection speed is calculated based on the difference between the distances and the detection time at each distance.

In S2107, the sequence control unit 307 stores the information on the ejection speed calculated in S2106 in the memory 303. The ejection speed information stored in this step is subsequently used, if necessary, for data processing and drive control of the printing head 201.

In S2108, the sequence control unit 307 performs termination processing. To be more specific, since the calculation of the ejection speed is completed, the printing head 201 is retreated to a predetermined position, a standby state is set for the next printing operation, or cleaning processing of the printing head 201 is performed based on the obtained ejection speed information. The ejection speed calculation processing of FIG. 21 ends after this step.

Upon completion of the ejection speed calculation processing of FIG. 21, a table prestored in the memory 303 is referred to, in which the ejection speed and the adjustment value of the ejection timing are associated. Then, based on the ejection speed obtained by the processing of FIG. 21, an adjustment value of the ejection timing corresponding to the ejection speed is obtained from this table, and the ejection timing is adjusted by the adjustment value thus obtained. In the case of printing an image, the timing control unit 309 controls the timing of ejecting ink according to printing data.

As described above, in the present embodiment, the distance between the printing head 201 and the droplet detection sensor 205 is changed, and the time between the ejection and detection of the ink droplet is detected for each of the plurality of distances (FIGS. 20A and 20C). Then, the ejection speed is calculated based on each distance difference and the detection time difference (FIGS. 20B and 20D). This makes it possible to accurately calculate the ejection speed of the ink droplets even in a state where the apparatus is not assembled with high accuracy. By detecting the detection times for four or more distances, it is possible to accurately obtain the relationship between the individual differences of the printing apparatus and the printing head, the physical properties of each ink color, the usage situation and environment, and the attenuation of the ejection speed at each separation distance that may be affected by the above. Furthermore, the deterioration in image quality due to deviation in the landing position can be suppressed by adjusting the ejection timing based on the ejection speed.

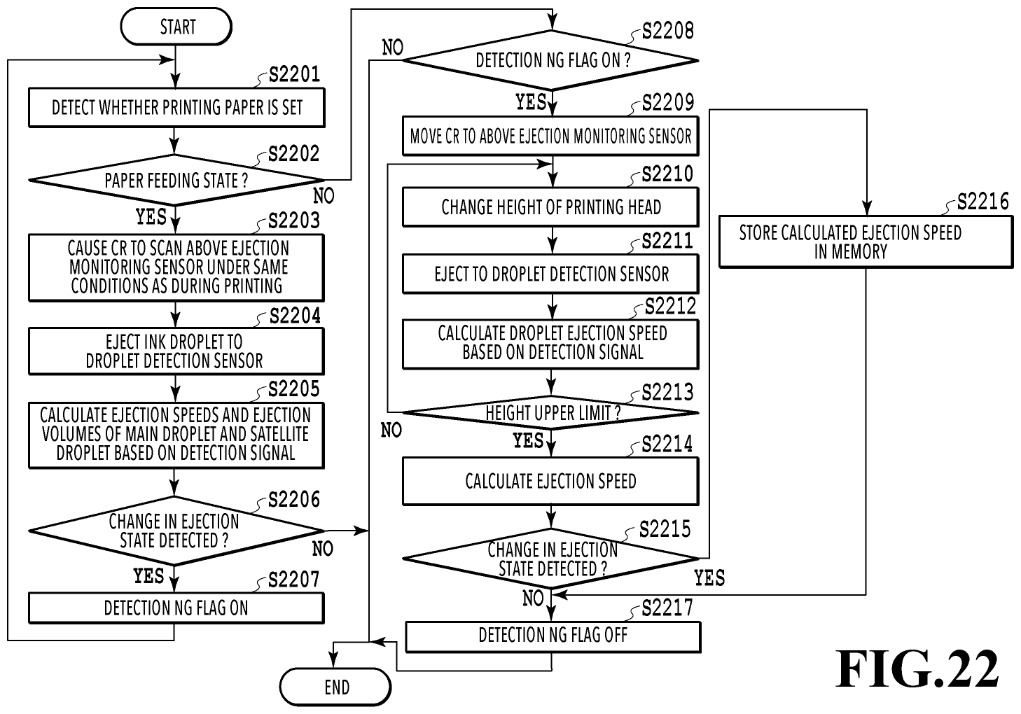

The process of calculating the ejection speed and storing the calculated ejection speed information in the memory 303 need only be performed if it is determined that there is a change in the ejection state, and does not need to be performed if there is no problem with the ejection state. FIG. 22 shows a flowchart of processing to monitor the ejection state and adjust the ejection timing when it is determined that there is a change in the ejection state.

In S2201, the CPU 301 uses the paper detection sensor 204 to detect whether or not the printing paper 203 is set.

In S2202, the CPU 301 determines whether or not the printing apparatus 100 is in the paper feeding state, based on the detection result obtained in S2201. The processing proceeds to S2203 if the determination result in this step is true, or proceeds to S2208 if the determination result is false.

The processing of S2203 to S2205 is the same as the processing (S601 to S603) in the detection processing (see FIG. 6) according to the first embodiment.

In S2203, the CPU 301 causes the CR 202 to scan under the same conditions as during printing and pass over the droplet detection sensor 205.

In S2204, the CPU 301 causes ink droplets to be ejected toward the droplet detection sensor 205 so that the ink droplets pass through the light beam 404.

In S2205, the CPU 301 calculates the ejection speed and ejection volume of the main droplet and the ejection speed and ejection volume of the satellite droplet, based on the detection signal from the light receiving element 402. The calculation method is the same as that in the first embodiment (see FIG. 6), and thus description thereof will be omitted here.

In S2206, the initial or past ejection state (reference state) is compared with the current ejection state to determine whether a change in the ejection state is detected. If the determination result in this step is true, the processing proceeds to S2207. On the other hand, if the determination result in this step is false, the series of processing ends.

In S2207, the CPU 301 sets the flag value of the detection NG flag stored in the memory 303 to ON. Upon completion of the processing in S2207, the processing returns to S2201 to detect whether or not the printing paper is set, and the processing is repeated until the printing apparatus is no longer in the paper feeding state (NO in S2202).

In S2208, the CPU 301 determines whether the flag value of the detection NG flag stored in the memory 303 is ON. If the determination result in this step is true, it is determined that there is a change in the ejection state, and the processing proceeds to S2209. On the other hand, if the determination result in this step is false, it is determined that there is no change in the ejection state, and the series of processing ends.

In the processing of S2209 to S2215, the droplet detection processing is performed without driving the CR 202. Specifically, as described with reference to FIGS. 5A to 5D, the lift motor 211 is driven to increase the distance between the printing head 201 and the droplet detection sensor 205, and the height of the printing head 201 is changed in multiple steps. The ejection speed of the ink droplet ejected from the printing head 201 corresponding to each step is detected.

In S2209, the CPU 301 moves the CR 202 to above the droplet detection sensor 205.

In S2210, the CPU 301 drives the lift motor 211 to move the printing head 201 to the first distance H1.

In S2211, the head control unit 310 and the head control circuit 305 in the CPU 301 cause ink droplets to be ejected from the printing head 201 toward the droplet detection sensor 205 based on an ejection signal.

In S2212, the CPU 301 calculates the ejection speed of the ink droplet based on a detection signal from the light receiving element 402. In this step, the timing at which the amount of light changes as the ink droplet ejected from the printing head 201 passes through the light beam 404 is used. Specifically, the detection time (first detection time T1) between the generation of the ejection signal and the output of the detection signal is obtained as the detection time corresponding to the first distance H1 between the printing head 201 and the droplet detection sensor 205.

In S2213, the CPU 301 determines whether the current height of the printing head 201 has reached the set upper limit. If the determination result in this step is true, the processing proceeds to S2214. On the other hand, if the determination result in this step is false, the processing returns to S2210. In this example, the processing returns to S2210.

In S2210, the CPU 301 drives the lift motor 211 to move the printing head 201 to the second distance H2.

In S2211, the head control unit 310 and the head control circuit 305 in the CPU 301 cause ink droplets to be ejected from the printing head 201 toward the droplet detection sensor 205 based on an ejection signal.

In S2212, the CPU 301 calculates the ejection speed of the ink droplet based on a detection signal from the light receiving element 402. In this step, the timing at which the amount of light changes as the ink droplet ejected from the printing head 201 passes through the light beam 404 is used. Specifically, the detection time (second detection time T2) between the generation of the ejection signal and the output of the detection signal is obtained as the detection time corresponding to the second distance H2 between the printing head 201 and the droplet detection sensor 205.

Again in S2213, the CPU 301 determines whether the height of the printing head 201 has reached the set upper limit. If the determination result in this step is true, the processing proceeds to S2214. On the other hand, if the determination result in this step is false, the processing returns to S2210. As the height of the printing head 201 reaches the set upper limit, the processing exits the repetition of S2210 to S2213 and proceeds to S2214.

In S2214, the CPU 301 uses the detection times (times T1 to T4) for each of the obtained heights (distances H1 to H4) of the printing head 201 to calculate an ejection speed V of the ink droplet for each height difference, based on the respective distance differences and respective time differences. Specifically, a first ejection speed V1 of the ink droplet is calculated based on a distance difference between the distance H1 and the distance H2 and a time difference between the detection time T1 and the detection time T2. A second ejection speed V2 of the ink droplet is calculated based on a distance difference between the second distance H2 and the third distance H3 and a time difference between the second detection time T2 and the third detection time T3. A third ejection speed V3 of the ink droplet is calculated based on a distance difference between the third distance H3 and the fourth distance H4 and a time difference between the third detection time T3 and the fourth detection time T4.

In S2215, the CPU 301 compares each of the plurality of ejection speeds calculated in S2214 with a threshold value (preset) used to determine whether the image quality may be deteriorated, and determines whether the amount of change in each of the ejection speeds is greater than the threshold value. If the determination result in this step is true, it is determined that there is a change in the ejection state, and the processing proceeds to S2216. On the other hand, if the determination result in this step is false, it is determined that there is no change in the ejection state, and the processing proceeds to S2217.

In S2216, the CPU 301 stores information on the ejection speed calculated in S2214 in the memory 303. The ejection speed information stored in this step is subsequently used, if necessary, for data processing and drive control of the printing head 201.

In S2217, the CPU 301 sets the flag value of the detection NG flag to OFF. The processing of FIG. 22 then ends.

As described above, according to the present embodiment, it is determined whether the printing paper is in the paper feed state, and if so, the droplet detection processing is performed while driving the CR. On the other hand, if the printing paper is not in the paper feeding state, the droplet detection processing is performed while changing the CR height. This configuration makes it possible to detect that the paper feeding state is released, calculate the ejection speed of the ink droplet, and adjust the ejection timing based on the calculated ejection speed, thereby suppressing the deterioration in image quality due to deviation in landing position.

### Sixth Embodiment

In the first embodiment, the description is given of the case where the ejection state is checked for a change, and if the amount of change in the current (latest) ejection state from the reference ejection state is greater than or equal to a certain amount, it is determined that there is a change in the ejection state. In the second embodiment, the description is given of the case where if it is determined by the ejection state determination sequence according to the first embodiment that there is a change in the ejection state, the printing apparatus executes processing according to the control processing mode setting selected by the user.

As a head registration adjustment method for adjusting the misalignment of the printing head in the printing apparatus, a method is known in which an image of a predetermined pattern, such as a lattice pattern, is printed on printing paper and the printed image is read using a reading unit such as a scanner. As the head registration adjustment using such a reading unit, first, there is automatic head registration adjustment, in which the amount of misalignment of the printed pattern is calculated to generate a correction value for correcting the misalignment of the printing head. Second, there is manual head registration adjustment, in which an image of a predetermined pattern, such as a lattice pattern, is printed on printing paper, and the printed image is visually checked to set a correction value for correcting the misalignment.

In general, the manual head registration adjustment can correct the print result to suit the user's preferences better than the automatic registration adjustment. Therefore, users who are not satisfied with the results of the automatic head registration adjustment often individually correct the print result by the manual head registration adjustment for specific printing conditions (also referred to as print conditions). A specific example of setting the printing conditions is setting the distance between the printing head and the printing paper.

The present embodiment assumes a case where, in a printing apparatus having a correction value generated by performing manual head registration adjustment under specific printing conditions, the ejection state is checked for a change under printing conditions for which the manual head registration adjustment is not performed. In such a case, if it is determined that there is a change in the ejection state and the correction operation is performed automatically according to the mode setting, the correction value information created by the user performing the manual head registration adjustment is updated, which may affect the printing accuracy.

Therefore, in the present embodiment, the operation of the ejection monitoring function is restricted by temporarily changing the mode setting upon execution of the manual head registration adjustment. In this respect, the present embodiment differs from the first and second embodiments. Note that the basic configuration is the same as those of the first and second embodiments, and thus description of the contents common to the first and second embodiments will be omitted as appropriate.

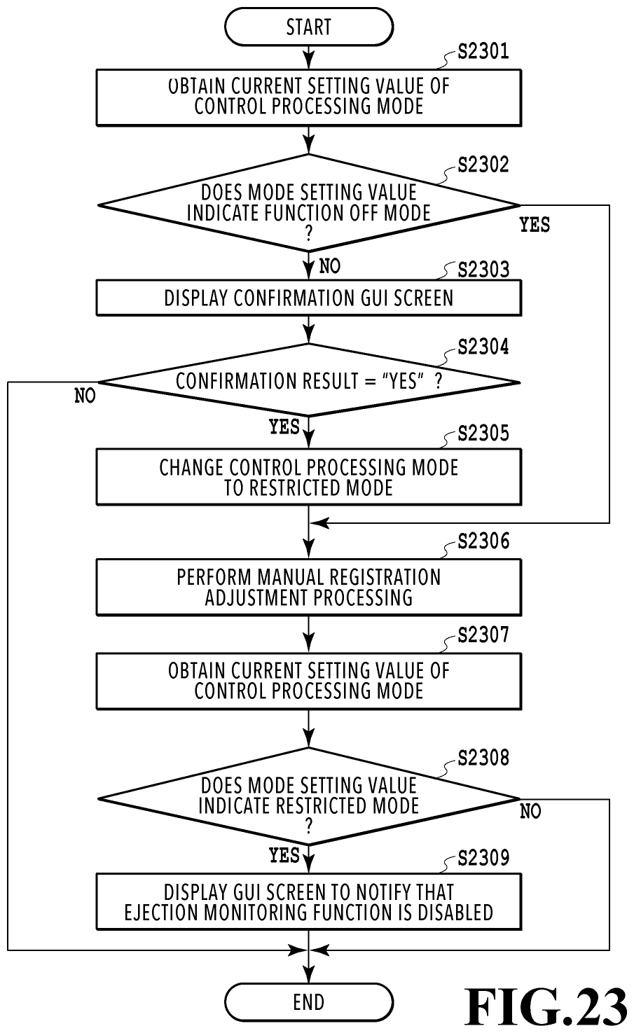

FIG. 23 is a flowchart of processing performed by the printing apparatus 100 according to the present embodiment, involving a transition to a restricted mode to restrict the setting of the ejection monitoring function. This processing is referred to as ejection monitoring restricted mode transition processing. The ejection monitoring restricted mode transition processing is executed by the CPU 301 according to a program stored in the memory 303. The ejection monitoring restricted mode transition processing is executed as the manual head registration adjustment is started.

The user operates the input/output unit 312 to start the manual head registration adjustment processing.

In S2301, the CPU 301 obtains the current setting value of the control processing mode. This setting value is stored in the memory 303.

In S2302, the CPU 301 uses the mode setting value obtained in S2301 to determine whether the mode setting of the ejection state determination sequence set for the printing apparatus is the function OFF mode. In other words, the CPU 301 determines whether the mode setting value obtained in S2301 indicates the function OFF mode. The processing proceeds to S2306 if the determination result in this step is true, or proceeds to S2303 if the determination result is false.

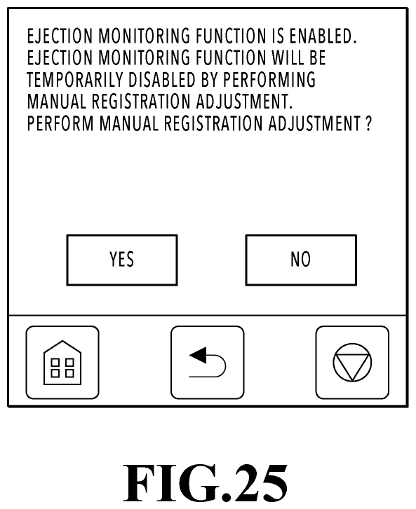

In S2303, the CPU 301 displays a confirmation GUI screen (see FIG. 25) on the input/output unit 312 to confirm that the ejection monitoring function will be disabled. The user who sees this GUI screen performs user input on the GUI screen (pressing “Yes” button or “No” button), and the CPU 301 receives the confirmation result from the user.

In S2304, the CPU 301 determines whether the user confirmation result obtained in S2303 is “Yes”. If the determination result in this step is true, the processing proceeds to S2305. On the other hand, if the determination result is false, the series of processing ends without performing the manual head registration adjustment.

In S2305, the CPU 301 sets the control processing mode of the printing apparatus to the restricted mode. Specifically, the setting value of the control processing mode stored in the memory 303 is updated to a value indicating the restricted mode.

In S2306, the CPU 301 performs the manual head registration adjustment processing. Specifically, an image of a predetermined pattern, such as a lattice pattern, is printed on the printing paper, and a correction value inputted through the input/output unit 312 based on the user's visual confirmation result is stored in the memory 303.

In S2307, the CPU 301 obtains the current setting value of the control processing mode. This setting value is stored in the memory 303.

In S2308, the CPU 301 uses the mode setting value obtained in S2307 to determine whether the mode setting of the ejection state determination sequence set for the printing apparatus is the restricted mode. In other words, the CPU 301 determines whether the mode setting value obtained in S2307 is the value indicating the restricted mode. The processing proceeds to S2309 if the determination result in this step is true, or the series of processing ends if the determination result is false.

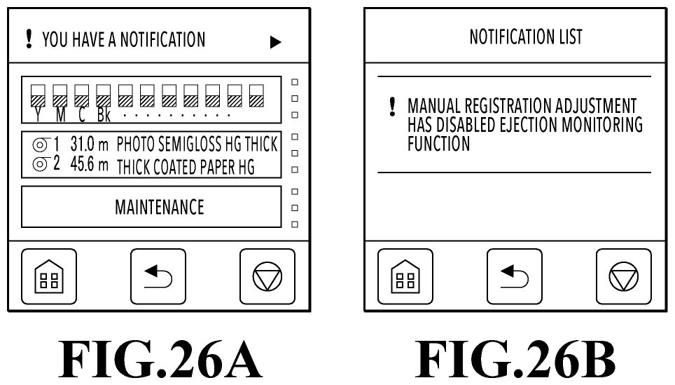

In S2309, the CPU 301 displays a warning GUI screen (see FIGS. 26A and 26B) on the input/output unit 312 to notify that the ejection monitoring function is disabled.

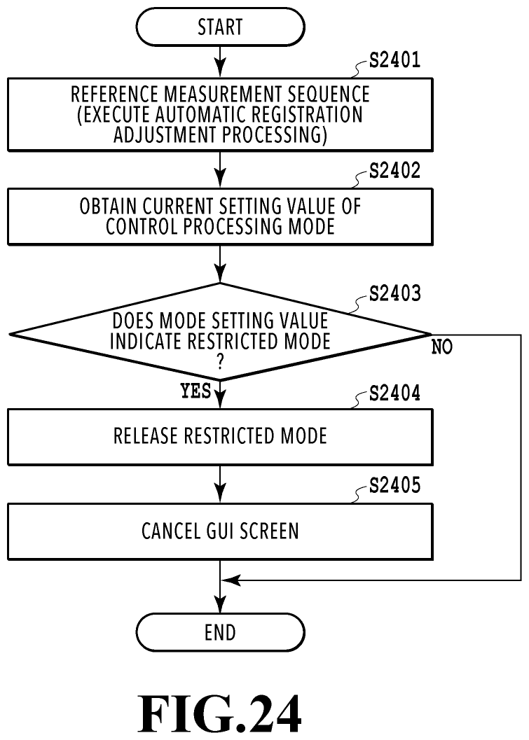

FIG. 24 is a flowchart of processing performed by the printing apparatus 100 according to the present embodiment to restore the mode setting of the ejection state determination sequence from the restricted mode. This processing is referred to as ejection monitoring restricted mode release processing. The ejection monitoring restricted mode release processing is executed by the CPU 301 according to a program stored in the memory 303. The ejection monitoring restricted mode release processing is executed as the automatic head registration adjustment is started in a state where the mode setting of the ejection state determination sequence is the restricted mode.

In S2401, the CPU 301 executes the automatic registration adjustment processing. Specifically, an image of a predetermined pattern such as a lattice pattern is printed on the printing paper, and the printed image is read using a reading unit such as a scanner. The amount of misalignment of the printed pattern is then calculated to generate a correction value for correcting the misalignment of the printing head, and the generated correction value is stored in the memory 303.

In S2402, the CPU 301 obtains the current setting value of the control processing mode. This setting value is stored in the memory 303.

In S2403, the CPU 301 uses the mode setting value obtained in S2402 to determine whether the mode setting of the ejection state determination sequence set for the printing apparatus is the restricted mode. In other words, the CPU 301 determines whether the mode setting value obtained in S2402 is the value indicating the restricted mode. The processing proceeds to S2404 if the determination result in this step is true, or the series of processing ends if the determination result is false.

In S2404, the CPU 301 releases the restricted mode of the printing apparatus. Specifically, the setting value of the control processing mode stored in the memory 303 is updated to the value before the restricted mode is set.

In S2405, the CPU 301 cancels the GUI screen (see FIG. 25) displayed on the input/output unit 312 for confirming that the ejection monitoring function is disabled.

FIG. 25 is a diagram showing an example of a GUI screen displayed on the input/output unit 312 as the user tries to perform the manual head registration adjustment in a state where the mode setting of the ejection state determination sequence is other than the function OFF mode in the present embodiment. As shown in FIG. 25, this GUI screen is displayed to notify the user that the ejection monitoring function will be disabled by performing the manual head registration adjustment, and to check with the user whether to proceed with the manual head registration adjustment processing (S2303 in FIG. 23).

FIGS. 26A and 26B are diagrams showing GUI screens displayed on the input/output unit 312 in a case where the mode setting of the ejection state determination sequence is the restricted mode as a result of performing the manual head registration adjustment in the present embodiment. In a case where the printing apparatus is in the standby state shown in FIG. 11A, a warning message is displayed in the upper part of the GUI screen so that the user can recognize the warning, as shown in FIG. 26A. FIG. 26B is a GUI screen showing details of the warning notified in FIG. 26A. As the user selects the warning message portion of the screen of FIG. 26A, the GUI screen displayed on the input/output unit 312 shifts from the screen of FIG. 26A to the screen of FIG. 26B. As shown in FIG. 26B, this screen includes a list of warnings (notification list) to be notified to the user. In this example, a warning is displayed to the effect that the mode setting of the ejection state determination sequence is set to the restricted mode by performing the manual head registration adjustment.

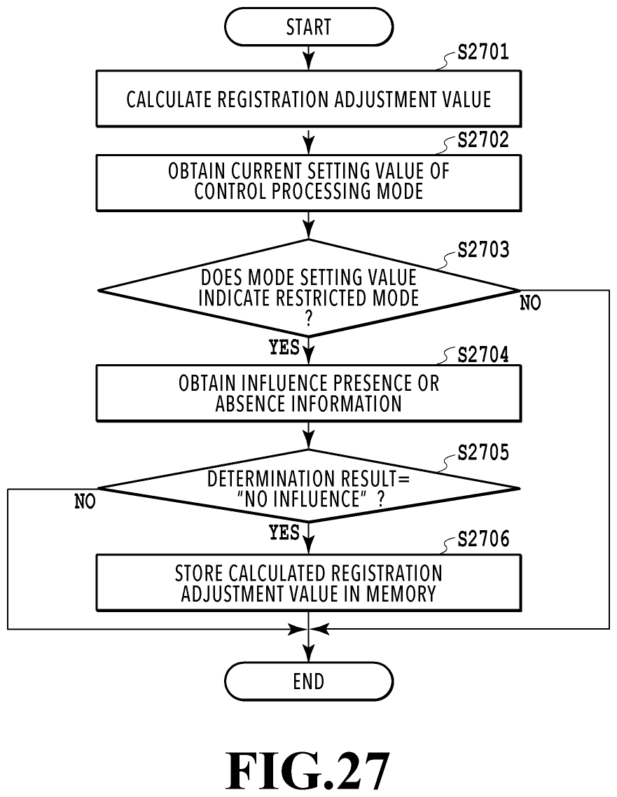

FIG. 27 is a flowchart of processing executed by the printing apparatus 100 according to the present embodiment to check the mode setting of the ejection state determination sequence, upon updating the registration adjustment value based on the ejection state determination result, and then restrict the update of the registration adjustment value. This processing is referred to as registration adjustment value update restriction processing. The registration adjustment value update restriction processing is executed by the CPU 301 according to a program stored in the memory 303.

The registration adjustment value update restriction processing is performed as the deterioration in the ejection state is detected in the ejection monitoring processing, and an adjustment value for correcting the deteriorated state is generated and stored in the memory (for example, S1510 in FIGS. 15 and S1917 in FIG. 19A and FIG. 19B).

In S2701, the CPU 301 calculates a registration adjustment value based on the rate of change in the ejection state.

In S2702, the CPU 301 obtains the current setting value of the control processing mode. This setting value is stored in the memory 303.

In S2703, the CPU 301 uses the mode setting value obtained in S2702 to determine whether the mode setting of the ejection state determination sequence set for the printing apparatus is the restricted mode. The processing proceeds to S2704 if the determination result in this step is true, or the series of processing ends if the determination result is false.

In S2704, the CPU 301 obtains information (referred to as influence presence or absence information) indicating whether or not the registration adjustment value calculated in S2701 may affect the printing conditions for which the manual head registration adjustment is performed. Since there is more than one registration adjustment value that may be calculated in S2701, it is necessary to know whether the same registration adjustment value is used under the printing conditions created by the manual head registration adjustment. Therefore, the influence presence or absence information is obtained in this step. Specific examples of the printing conditions include the distance between the printing head and the printing paper, the paper thickness, the CR speed, and the like.

In S2705, the CPU 301 determines whether the update using the registration adjustment value calculated in S2701 affects the printing conditions for which the manual head registration adjustment is performed, based on the influence presence or absence information obtained in S2704. The processing proceeds to S2706 if the determination result in this step is true, or the series of processing ends if the determination result is false.

In S2706, the CPU 301 stores (overwrites) in the memory 303 the registration adjustment value calculated in S2701.

As described above, the present embodiment is applied to the printing apparatus in which the manual head registration adjustment is performed under specific printing conditions to generate a correction value. In such a printing apparatus, it is assumed that the ejection state is checked for a change under the printing conditions for which the manual head registration adjustment is not performed. In such a case, if it is determined that there is a change in the ejection state and the correction operation is performed automatically according to the mode setting, the correction value information created by the user performing the manual head registration adjustment is updated, which may affect the printing accuracy. However, such a possibility can be reduced according to the present embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the ejection state of the nozzles can be detected with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-146349, filed Sep. 8, 2023, and No. 2024-039121, filed Mar. 13, 2024, which are hereby incorporated by reference wherein in their entirety.

What is claimed is:

1. A printing apparatus comprising:
a printing head having nozzles configured to eject droplets;
a carriage having the printing head mounted thereon;
a control unit configured to control the ejection of the droplets from the nozzles;
a first detection unit configured to detect the droplets ejected from the nozzles;
a first determination unit configured to determine an ejection state of the nozzles based on a detection result obtained by the first detection unit;
a reception unit configured to receive a user input to select a mode; and
a setting unit configured to set the mode based on the user input, wherein
the control unit causes the droplets to be ejected from the nozzles while moving the carriage relative to the first detection unit,
the first determination unit determines the ejection state of the nozzles based on the detection result of the droplets ejected while moving the carriage relative to the first detection unit, and
processing is executed according to the mode set by the setting unit if the first determination unit determines that there is a change in the ejection state.

2. The printing apparatus according to claim 1, wherein
the droplets are ejected from the nozzles onto a printing medium while moving the carriage relative to the printing medium.

3. The printing apparatus according to claim 1, wherein
the droplets include a main droplet and a satellite droplet, and
the main droplet ejected from the nozzle while moving the carriage is ejected along a trajectory different from that of the satellite droplet.

4. The printing apparatus according to claim 3, wherein
the first detection unit includes a light emitting unit configured to irradiate light,
a light receiving unit configured to receive the light emitted from the light emitting unit, and
an output unit configured to output a detection signal according to an amount of light received by the light receiving unit, wherein
the droplets ejected from the printing head block the light from the light emitting unit to the light receiving unit.

5. The printing apparatus according to claim 4, wherein
the first determination unit determines whether or not the ejection state of the nozzle is normal by using a first ejection speed and a first ejection volume corresponding to the main droplet as well as a second ejection speed and a second ejection volume corresponding to the satellite droplet.

6. The printing apparatus according to claim 5, further comprising:
a derivation unit configured to derive the first ejection speed and the first ejection volume corresponding to the main droplet as well as the second ejection speed and the second ejection volume corresponding to the satellite droplet.

7. The printing apparatus according to claim 6, wherein
the derivation unit derives the first ejection speed based on a time between ejection start and detection of the main droplet, which is obtained based on a first signal obtained by separating the detection signal, and on a distance between the carriage and the first detection unit, and
the derivation unit derives the first ejection volume based on an amount of change in the first signal.

8. The printing apparatus according to claim 7, wherein
the derivation unit derives the second ejection speed based on a time between ejection start and detection of the satellite droplet, which is obtained based on a second signal obtained by separating the detection signal, and on a distance between the carriage and the first detection unit, and
the derivation unit derives the second ejection volume based on an amount of change in the second signal.

9. The printing apparatus according to claim 8, wherein
the first determination unit determines, for each of the main droplet and the satellite droplet, whether the ejection volume derived by the derivation unit is greater than or equal to a first threshold value associated with the ejection volume and the ejection speed derived by the derivation unit is greater than or equal to a second threshold value associated with the ejection speed, and
it is determined that there is no change in the ejection state of the nozzle if the determination result is true, while it is determined that there is a change in the ejection state of the nozzle if the determination result is false.

10. The printing apparatus according to claim 9, further comprising:
a storage unit configured to store the first threshold value and the second threshold value, wherein
the first threshold value and the second threshold value stored in the storage unit are updated based on the detection result from the first detection unit.

11. The printing apparatus according to claim 1, wherein
the first determination unit determines the ejection state of the nozzle based on the detection result of the droplet ejected from the nozzle while moving the carriage at a constant speed.

12. The printing apparatus according to claim 1, wherein
the nozzle to be determined by the first determination unit is decided based on whether or not a dot count of the nozzle exceeds a predetermined threshold.

13. The printing apparatus according to claim 1, further comprising:
a notification unit configured to notify a user of the change if the first determination unit determines that there is a change in the ejection state.

14. The printing apparatus according to claim 1, wherein
a height of the printing head can be changed in stages, and
the ejection speed of the droplet is derived based on a distance that is a difference between a first height before the change and a second height after the change, and on a time difference between a first detection time corresponding to the first height and a second detection time corresponding to the second height.

15. The printing apparatus according to claim 1, further comprising:
an execution unit configured to execute registration adjustment processing if the first determination unit determines that there is a change in the ejection state.

16. The printing apparatus according to claim 1, further comprising:
an execution unit configured to execute processing to change a distance between the printing head and a printing medium if the first determination unit determines that there is a change in the ejection state.

17. The printing apparatus according to claim 1, further comprising:
an execution unit configured to execute processing to change a pulse width of a driving pulse applied to the printing head if the first determination unit determines that there is a change in the ejection state.

18. The printing apparatus according to claim 15, wherein
the mode selected by a user is one of a plurality of modes, and
the plurality of modes include a first mode in which the execution unit automatically executes the registration adjustment processing if the first determination unit determines that there is a change in the ejection state.

19. The printing apparatus according to claim 18, wherein
the plurality of modes include a second mode in which a warning message recommending execution of the registration adjustment processing is displayed, if the first determination unit determines that there is a change in the ejection state.

20. The printing apparatus according to claim 19, wherein
a user instructs the execution of the recommended registration adjustment processing via a GUI screen displayed in the second mode.

21. The printing apparatus according to claim 20, wherein
the plurality of modes include a third mode in which the first determination unit does not execute the processing of determining the ejection state of the nozzle.

22. The printing apparatus according to claim 1, further comprising:
an obtaining unit configured to obtain a peak value of a detection signal;
a second determination unit configured to determine whether the peak value is smaller than or equal to a first threshold value and larger than or equal to a second threshold value; and
an adjustment unit configured to adjust a parameter for test ejection if the result of the determination by the second determination unit is false.

23. The printing apparatus according to claim 22, further comprising:
a third determination unit configured to determine whether a signal intensity of the detection signal is Low if the result of the determination by the second determination unit is false, wherein
the adjustment unit increases the parameter if the result of the determination by the third determination unit is true, and decreases the parameter if the result of the determination by the third determination unit is false.

24. The printing apparatus according to claim 1, further comprising:
a second detection unit configured to detect a printing medium; and
a fourth determination unit configured to determine whether or not the printing medium is in a paper feeding state based on the detection result from the second detection unit, wherein
a method of controlling the carriage by the control unit is changed based on the result of the determination by the fourth determination unit, and the control unit causes the droplets to be ejected from the nozzles according to the changed control method, and
the first determination unit determines the ejection state of the nozzles based on the detection result of the droplets ejected according to the changed control method.

25. The printing apparatus according to claim 24, wherein
if the fourth determination unit determines that the printing medium is in the paper feeding state, the control unit causes the droplets to be ejected from the nozzles while moving the carriage relative to the first detection unit, and
the first determination unit determines the ejection state of the nozzles based on the detection result of the ejected droplets while moving the carriage relative to the first detection unit.

26. The printing apparatus according to claim 25, wherein
if the fourth determination unit determines that the printing medium is not in the paper feeding state, the control unit changes the height of the printing head in stages and causes the droplets to be ejected from the nozzles at each of the changed heights, and
the first determination unit determines the ejection state of the nozzles based on the detection result of the droplets ejected at each of the changed heights.

27. The printing apparatus according to claim 26, further comprising:
a table in which the droplet ejection speed and ejection timing upon execution of printing on the printing medium are associated, wherein
the height of the printing head can be changed in stages,
the droplet ejection speed is derived based on a distance that is a difference between a first height before the change and a second height after the change, and on a time difference between a first detection time corresponding to the first height and a second detection time corresponding to the second height, and
the droplet ejection timing is changed based on the derived droplet ejection speed by referring to the table.

28. The printing apparatus according to claim 1, wherein
if the first determination unit determines that there is a change in the ejection state, automatic registration processing is performed to automatically perform registration adjustment processing,
a user can individually perform manual head registration adjustment to performs registration adjustment processing for any printing condition, and
in a case of performing the manual head registration adjustment, the mode set by the setting unit is switched.

29. The printing apparatus according to claim 28, further comprising:
a display control unit configured to cause a display unit to display a confirmation GUI screen for confirming to a user that an ejection monitoring function to monitor the ejection state of the nozzles is to be disabled in a case of performing the manual head registration adjustment.

30. The printing apparatus according to claim 29, wherein
the mode is shifted to a restricted mode in which the ejection monitoring function is disabled based on a user input via the confirmation GUI screen.

31. The printing apparatus according to claim 30, wherein
in a case where the mode is shifted to the restricted mode after the manual head registration adjustment is performed, the display control unit causes the display unit to display a warning GUI screen for notifying that the ejection monitoring function is disabled.

32. The printing apparatus according to claim 31, wherein
if the mode is the restricted mode upon execution of the automatic registration processing, the restricted mode is released.

33. The printing apparatus according to claim 32, further comprising:
a fifth determination unit configured to determine whether to update a registration adjustment value of a printing condition with a value obtained by the automatic registration processing if the printing condition is adjusted by the manual head registration adjustment upon execution of the automatic registration processing.

34. A method for controlling a printing apparatus including
a printing head having nozzles configured to eject droplets,
a carriage having the printing head mounted thereon,
a control unit configured to control the ejection of the droplets from the nozzles,
a detection unit configured to detect the droplets ejected from the nozzles,
a reception unit configured to receive a user input to select a mode, and
a setting unit configured to set the mode based on the user input, wherein
the control unit causes the droplets to be ejected from the nozzles while moving the carriage relative to the detection unit,
the method comprising the steps of:
determining the ejection state of the nozzles based on the detection result obtained by the detection unit and determining the ejection state based on the detection result of the droplets ejected while moving the carriage relative to the detection unit; and
executing processing according to the mode set by the setting unit if it is determined in the determining that there is a change in the ejection state.

35. A non-transitory computer readable storage medium storing a program for causing a computer to execute a method for controlling a printing apparatus including
a printing head having nozzles configured to eject droplets,
a carriage having the printing head mounted thereon,
a control unit configured to control the ejection of the droplets from the nozzles,
a detection unit configured to detect the droplets ejected from the nozzles,
a reception unit configured to receive a user input to select a mode, and
a setting unit configured to set the mode based on the user input, wherein
the control unit causes the droplets to be ejected from the nozzles while moving the carriage relative to the detection unit,
the method comprising the steps of:
determining the ejection state of the nozzles based on the detection result obtained by the detection unit and determining the ejection state based on the detection result of the droplets ejected while moving the carriage relative to the detection unit; and
executing processing according to the mode set by the setting unit if it is determined in the determining that there is a change in the ejection state.
